(19) United States
(12) Patent Application Publication
(10) Pub. No.: US 2022/0297352 A1
(43) Pub. Date: Sep. 22, 2022

(54) PROCESS FOR RECOVERING SULFOPOLYESTER

(71) Applicant: Eastman Chemical Company, Kingsport, TN (US)

(72) Inventors: Kenny Randolph Parker, Afton, TN (US); Scott Ellery George, Kingsport, TN (US); Charles Stuart Everett, Kingsport, TN (US); Kevin Leonard Urman, Gonzalez, FL (US); Joshua Seth Cannon, Greeneville, TN (US); Weijun Kevin Wang, Kingsport, TN (US); Chaoxiong Ma, Kingsport, TN (US)

(73) Assignee: Eastman Chemical Company, Kingsport, TN (US)

(21) Appl. No.: 17/633,803

(22) PCT Filed: Aug. 7, 2020
(86) PCT No.: PCT/US2020/045325

§ 371 Date: Feb. 8, 2022

Related U.S. Application Data
(60) Provisional application No. 62/884,306, filed on Aug. 8, 2019.
(60) Provisional application No. 62/884,310, filed on Aug. 8, 2019.
(60) Provisional application No. 62/884,317, filed on Aug. 8, 2019.
(60) Provisional application No. 62/884,325, filed on Aug. 8, 2019.
(60) Provisional application No. 62/884,331, filed on Aug. 8, 2019.
(60) Provisional application No. 62/884,337, filed on Aug. 8, 2019.

(51) Int. Cl. B29B 17/02; C08G 63/89

(52) U.S. Cl. CPC B29B 17/02; C08G 63/89; B29B 2017/0224; B29B 2017/0015

(57) ABSTRACT

The present disclosure provides a process of recovering sulfopolyester comprising reduced impurity. Sulfopolyester is recovered from a composite material comprising water-dispersible sulfopolyester polymer and at least one non-water-dispersible polymer. The process includes washing the composite material comprising water-dispersible sulfopolyester with a solvent composition. The recovered sulfopolyester can be generated as a concentrated aqueous dispersion, a polymer melt, or a sulfopolyester solid.

### TECHNICAL FIELD

The present disclosure describes processes for recovering sulfopolyester from composite material.

### BACKGROUND OF THE INVENTION

Recycling involves the process of turning material that would otherwise be thrown away into new products. Recycling is beneficial to the environment by reducing waste sent to the landfills, conserving natural resources, preventing pollution, and saving energy.

Many composite materials are made with water-dispersible polymers. An example of a water-dispersible polymer is sulfopolyester. Sulfopolyester is used in the formation of fibers and fibrous articles including non-woven fabric, multicomponent fibers, films, clothing articles, personal care products such as wipes, feminine hygiene products, diapers, adult incontinence briefs, medical disposables, protective fabrics and layers, geotextiles, industrial wipes, and filter media.

In the past, processes have been developed for recycling or recovering sulfopolyester from material ready to be thrown out, as recovered sulfopolyester can be used to make new articles. Accordingly, there is continued interest in developing improved processes for recovering sulfopolyester with increased purity, more efficiently and economically.

### BRIEF SUMMARY OF THE INVENTION

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter.

A process for recovering sulfopolyester from composite material is provided. The process comprises: washing the composite material with a solvent composition to remove a portion of surface impurities and to form a washed composite material, wherein the washing is conducted at a temperature where less than 2% of the water-dispersible sulfopolyester is removed from the composite material, and wherein the composite material comprises a water-dispersible sulfopolyester and one or more water non-dispersible polymers; opening the washed composite material with water at a temperature of greater than 60° C. to produce an aqueous dispersion and water non-dispersible polymers, wherein the aqueous dispersion comprises sulfopolyester; and recovering sulfopolyester from the aqueous dispersion.

Moreover, a process for recovering sulfopolyester from fibers, for example multicomponent fibers comprising water-dispersible sulfopolyester is provided. The process comprises cutting the fibers into short cut fibers; washing the short cut fibers comprising water-dispersible sulfopolyester with a wash solvent composition at a temperature where less than 2% of the water-dispersible sulfopolyester is removed from the composite material, wherein the short cut fibers comprises a water-dispersible sulfopolyester and one or more water non-dispersible polymers; opening the short cut fibers with water at a temperature of greater than 60° C. to produce an aqueous dispersion and water non-dispersible polymers, wherein the aqueous dispersion comprises sulfopolyester; and recovering sulfopolyester from the aqueous dispersion.

In embodiments, the washed composite material and washed short cut fibers can be mixed with treated water prior to opening, wherein the water has been treated to remove multivalent metal cations.

The wash solvent composition comprises water. The wash solvent composition can also comprise one or more surfactants and/or one or more organic solvents. Examples of surfactants include anionic surfactants and/or non-ionic surfactants. Examples of organic solvents include alcohol, acetone, ketone, ether, and/or ester. In embodiments the wash solvent composition consists essentially of water.

The washing is performed with the wash solvent composition at a temperature between 20° C. and 60° C., between 20° C. and 50° C., between 20° C. and 40° C., and between 20° C. and 30° C. Washing comprises contacting the composite material or the fibers with shear force to remove at least a portion of the impurities. Washing is performed between 15 seconds to 15 minutes, 20 seconds to 12 minutes, 30 seconds to 10 minutes, 1 minute to 8 minutes, 1 minute to 5 minutes, or 1 minute to 3 minutes.

After washing, the washed composite material or washed short cut fiber is opened with water at a temperature ranging from 61° C. to 140° C., from 65° C. to 135° C., from 70° C. to 130° C., from 75° C. to 125° C., from 80° C. to 120° C., from 80° C. to 115° C., from 80° C. to 110° C., from 80° C. to 105° C., from 80° C. to 100° C., or from 80° C. to 90° C. Opening is performed with shear force for a period of time ranging from to 10 secs to 10 minutes, 20 secs to 8 minutes, 20 secs to 5 minutes, 20 secs to 4 minutes, 20 secs to 3 minutes, 20 secs to 2 minutes, or 20 secs to 1 minute.

Recovering the sulfopolyester comprises removing water from the aqueous dispersion. The recovered sulfopolyester includes a concentrated sulfopolyester dispersion, a solid form of the sulfopolyester including some moisture, and a polymer melt.

Water can be removed by evaporation, by precipitation, or by using one or more membrane filtration systems. Examples of one or more membrane filtration systems for removing water include one or more of an ultrafiltration system, a microfiltration system, or nanofiltration system.

Recovering sulfopolyester using membrane filtration technology provides a concentrated sulfopolyester dispersion. In embodiments, the concentrated sulfopolyester dispersion comprises sulfopolyester between 1 wt % to 40 wt %, between 1 wt % to 35 wt %, between 5 wt % to 30 wt %, between 10 wt % to 30 wt %, between 15 wt % to 30 wt %, between 20 wt % to 30 wt %, or between 25 wt % to 30 wt %, relative to the total weight of the concentrated sulfopolyester dispersion.

Water also can be removed by evaporation using an evaporator. In embodiments, the sulfopolyester recovered by evaporation is in a solid form comprising less than 5 wt % moisture content, less than 4 wt % moisture content, less than 3 wt % moisture content, less than 2 wt % moisture content, less than 1 wt % moisture content, or less than 0.5 wt % water content, relative to the total weight of the solid. In other embodiments, sulfopolyester recovered by evaporation can be produced in the form of a dispersion in which the percent of polymer ranges from 1% to 10%, from 11% to 20%, from 21% to 30%, from 31% to 40%, from 41% to 50%, from 51% to 60%, from 61% to 70%, or from 71% to 80%. In still other embodiments, the sulfopolyester recovered by evaporation with added heat can be in the form of a polymer melt, which when cooled yields sulfopolyester in solid form.

In embodiments, the process further comprises secondary filtration of the aqueous dispersion comprising sulfopolyester prior to recovering the sulfopolyester. The secondary filtration comprises passing the aqueous dispersion through a pleated cartridge filter and/or other filters.

In embodiments, the process recovers 75% to 99.9%, 75% to 99%, 80% to 98%, 85% to 97%, 90% to 96%, or 91% to 95% of the sulfopolyester in the composite material or the fibers.

Moreover, each step of the process of recovering sulfopolyester from composite material, composite solids, or multicomponent fibers can be performed in a separate zone. In embodiments, washing is performed in the wash zone; mixing is performed in the mix zone; opening is performed in the opening zone; recovering the sulfopolyester is performed in the recovery zone. In embodiments, the process further comprises a primary solid liquid separation (SLS) zone, a secondary (SLS) zone, a primary concentration zone, and a secondary concentration zone for recovering the sulfopolyester.

The recovered sulfopolyester dispersion obtained by the process described herein comprises recovered sulfopolyester and a solvent composition; wherein the dispersion comprises 0.01 wt % to 5 wt % impurities, relative to the total weight of the recovered sulfopolyester dispersion. The recovered sulfopolyester can also comprise washed (pre-washed) recovered sulfopolyester dispersion comprising recovered sulfopolyester and solvent composition; wherein the dispersion has a reduced impurity concentration of at least 80% or more as compared to non-prewashed recovered sulfopolyester dispersion. Moreover, the recovered sulfopolyester can comprise washed (pre-washed) recovered sulfopolyester dispersion comprising an impurity level ranging from 0.01% to 5%. Further, the recovered sulfopolyester can comprises a washed (pre-washed) recovered sulfopolyester dispersion comprising substantially a two phase system.

The recovered sulfopolyester and the recovered sulfopolyester dispersion can be used to make various articles and products including multicomponent fibers, fabric, clothing articles, cosmetics, and personal care products. In embodiments, the recovered sulfopolyester dispersion can be used for making sizing agent, dust suppressant, binding agent, and ink.

### BRIEF DESCRIPTION OF THE DRAWINGS

FIG. 1 shows an exemplary process of recovering sulfopolyester from composite material.

FIG. 2 shows an embodiment for the process of recovering sulfopolyester from composite material.

FIG. 3 shows an embodiment for the process of recovering sulfopolyester from short cut multicomponent fiber.

### DETAILED DESCRIPTION

The present disclosure describes a novel process for recovering sulfopolyester from articles that we use daily. For example, various articles are made of composite materials that are manufactured with water-dispersible sulfopolyester. Sulfopolyester can be recovered from these articles and reused to make new and useful articles and products.

The inventors surprisingly discovered that including a step of washing (or pre-washing) the starting material comprising sulfopolyester in the process of recovery removes additional undesirable impurities that may have been added to the material through the manufacturing process. The terms “pre-washed” and “washed” are used interchangeably to mean washing the composite material, the composite solids, or the multicomponent fibers prior to opening and/or prior to mixing with treated water. The term “impurities” is defined as any liquid or solid on the surface of the unopened fiber that does not comprise sulfopolyester or the base polymer in the fiber. Impurities include, but are not limited to, surface impurities comprise oil, slip agents, fillers, surface friction modifiers, light and heat stabilizers, extrusion aids, antistatic agents, colorants, dyes, pigments, fluorescent brighteners, antimicrobials, anticounterfeiting markers, antioxidants, hydrophobic and hydrophilic enhancers, viscosity modifiers, slip agents, tougheners, or adhesion promoters.

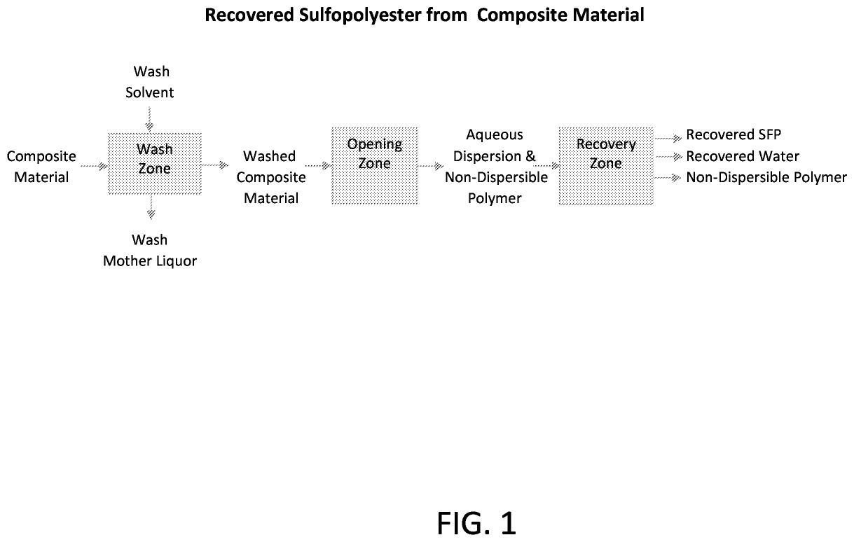

FIG. 1 provides an exemplary method of recovering sulfopolyester from a composite material, wherein the method comprises:
a. washing the composite material with a solvent composition to remove a portion of surface impurities to form a washed composite material; wherein the washing is conducted at a temperature where less than 2% of the water-dispersible sulfopolyester is removed from the composite material; and wherein the composite material comprises a water-dispersible sulfopolyester and one or more water non-dispersible polymers;
b. opening the washed composite material with water at a temperature of greater than 60° C. to produce an aqueous dispersion and water non-dispersible polymers; wherein said aqueous dispersion comprises sulfopolyester; and
c. recovering sulfopolyester from the aqueous dispersion.

In embodiments, the process of recovering the sulfopolyester includes washing the material composed of sulfopolyester at a temperature of less than 60° C. with a wash solvent composition, opening the washed composite material at a temperature of greater than 60° C., and recovering sulfopolyester from the aqueous dispersion in the form of an aqueous dispersion, concentrated aqueous dispersion, a solid, or a polymer melt.

The starting materials used in the process described herein includes composite materials (composite) composed of sulfopolyester and from which the sulfopolyester is being recovered. The term “composite material” refers to material made from two or more constituent materials with different physical and chemical properties. The individual components remain separate and distinct in the final material. In embodiments, the components of a composite material described herein include water-dispersible sulfopolyester and one or more water non-dispersible polymers. The terms “composite material”, “composite solid”, and “composite solids” are used interchangeably to refer to the composite or composite material.

The term “water-dispersible” in reference to sulfopolyester is intended to be synonymous with the terms “water-dissipatable”, “water-disintegratable”, “water-dissolvable”, “water-dispellable”, “water soluble”, “water-removable”, “hydro-soluble”, and “hydrodispersible”. It is also intended to mean that the sulfopolyester component is removed from the composite material, such as a multicomponent fiber, and is dispersed or dissolved by the action of water. In the case of a composite material, the sulfopolyester is removed so as to enable the release and separation of the water non-dispersible fibers contained therein. The terms “dispersed”, “dispersible”, “dissipate”, or “dissipatable” mean that, using a sufficient amount of deionized water, for example, 100:1 water:fiber by weight, to form a loose suspension or slurry of the water non-dispersible polymer, at a temperature of greater than 60° C., and within a time period of up to 5 days, the sulfopolyester component dissolved, disintegrates, disassociates, or separates from the water non-dispersible polymer in the composite material, leaving behind a plurality of solids.

The water-dispersible sulfopolyesters contained in the composite material, composite solid, or multicomponent fibers comprise dicarboxylic acid monomer residues, sulfomonomer residues, diol monomer residues, as repeating units. The sulfomonomer may be a dicarboxylic acid, a diol, or hydroxycarboxylic acid. Thus, the term “monomer residue”, as used herein, means a residue of a dicarboxylic acid, a diol, or a hydroxycarboxylic acid. A “repeating unit”, as used herein, means an organic structure having 2 monomer residues bonded through a carbonyloxy group. The water-dispersible sulfopolyesters contain substantially equal molar proportions of acid residues (100 mole %) and diol residues (100 mole %) which react in substantially equal proportions such that the total moles of repeating units is equal to 100 mole %. The sulfopolyester will contain 100 mole % total diacid and 100 mole % total diol residues. The mole percentages provided herein, therefore, may be based on the total moles of diacid residues, the total moles of diol residues, or the total moles of repeating units. For example, a sulfopolyester containing 30 mole % of a sulfomonomer, which may be a dicarboxylic acid, a diol, or hydroxycarboxylic acid, based on the total repeating units, means that the sulfopolyester contains 30 mole % sulfomonomer out of a total of 100 mole % repeating units. Thus, there are 30 moles of sulfomonomer residues among every 100 moles of repeating units. Similarly, a sulfopolyester containing 30 mole % of a dicarboxylic acid sulfomonomer, based on the total acid residues, means the sulfopolyester contains 30 mole % sulfomonomer out of a total of 100 mole % acid residues. Thus, in this latter case, there are 30 moles of sulfomonomer residues among every 100 moles of acid residues.

The sulfopolyesters described herein have an inherent viscosity, abbreviated hereinafter as “lh.V.”, of at least 0.1 dL/g, 0.2 to 0.3 dL/g, or 0.3 dL/g, measured in a 60/40 parts by weight solution of phenol/tetrachloroethane solvent at 25° C. and at a concentration of 0.5 g of sulfopolyester in 100 mL of solvent. The term “polyester”, as used herein, encompasses both “homopolyesters” and “copolyesters” and includes synthetic polymer prepared by the polycondensation of difunctional carboxylic acids with difunctional hydroxyl compound. As used herein, the term “sulfopolyester” means any polyester comprising a sulfomonomer.

Typically, the difunctional carboxylic acid is a dicarboxylic acid and the difunctional hydroxyl compound is a dihydric alcohol such as, for example glycols and diols. Alternatively, the sulfopolyester can contain hydroxy acid monomers, for example, p-hydroxybenzoic acid, and the difunctional hydroxyl compound may be an aromatic nucleus bearing 2 hydroxy substituents such as, for example, hydroquinone. Aromatic hydroxy acids and aromatic diols are within scope although are less preferred. The term “residue”, as used herein, means any organic structure incorporated into the polymer through a polycondensation reaction involving the corresponding monomer. Thus, the dicarboxylic acid residue may be derived from a dicarboxylic acid monomer or its associated acid halides, esters, anhydrides, or mixtures thereof. As used herein, therefore, the term dicarboxylic acid is intended to include dicarboxylic acids and any derivative of a dicarboxylic acid, including its associated acid halides, esters, half-esters, salts, half-salts, anhydrides, mixed anhydrides, or mixtures thereof, useful in a polycondensation process with a diol to make a high molecular weight polyester.

The water-dispersible sulfopolyester includes one or more dicarboxylic acid residues. Depending on the type and concentration of the sulfomonomer, the dicarboxylic acid residue may comprise from 60 to 100 mole % of the acid residues. Other examples of concentration ranges of dicarboxylic acid residues are from 60 mole % to 95 mole %, and 70 mole % to 95 mole %. Examples of dicarboxylic acids that may be used include aliphatic dicarboxylic acids, alicyclic dicarboxylic acids, aromatic dicarboxylic acids, or mixtures of two or more of these acids. Thus, suitable dicarboxylic acids include, but are not limited to, succinic; glutaric; adipic; azelaic; sebacic; fumaric; maleic; itaconic; 1,3-cyclohexanedicarboxylic; 1,4cyclohexanedicarboxylic; diglycolic; 2,5-norbornanedicarboxylic; phthalic; terephthalic; 1,4-naphthalenedicarboxylic; 2,6-naphthalenedicarboxylic; diphenic; 4,4′-oxydibenzoic; 4,4′-sulfonyidibenzoic; and isophthalic. In embodiments, the dicarboxylic acid residues are isophthalic, terephthalic, and 1,4-cyclohexanedicarboxylic acids, or if diesters are used, dimethyl terephthalate, dimethyl isophthalate, and dimethyl-1,4-cyclohexanedicarboxylate. In particular embodiments, the dicarboxylic acid residues are isophthalic and terephthalic acid. Although the dicarboxylic acid methyl ester is the most often used, it is also acceptable to include higher order alkyl esters, such as ethyl, propyl, isopropyl, butyl, and so forth. In addition, aromatic esters, particularly phenyl, also may be employed.

The water-dispersible sulfopolyester includes 4 to 40 mole %, based on the total repeating units, of residues of at least one sulfomonomer having 2 functional groups and one or more sulfonate groups attached to an aromatic or cycloaliphatic ring wherein the functional groups are hydroxyl, carboxyl, or a combination thereof. Additional examples of concentration ranges for the sulfomonomer residues are 4 to 35 mole %, 8 to 30 mole %, and 8 to 25 mole %, based on the total repeating units. The sulfomonomer may be a dicarboxylic acid or ester thereof containing a sulfonate group, a diol containing a sulfonate group, or a hydroxy acid containing a sulfonate group. The term “sulfonate” refers to a salt of a sulfonic acid having the structure “—SO₃M” wherein M is the cation of the sulfonate salt. The cation of the sulfonate salt may be a metal ion such as Li⁺, Na⁺, K⁺, Mg⁺⁺, Ca⁺⁺, Ni^{30 +}, Fe⁺⁺, and the like. Multivalent cations, such as Mg⁺⁺, Ca⁺⁺, Ni⁺⁺, Fe⁺⁺, are permissible in small amounts, but are not preferred in the practice of this invention. Alternatively, the cation of the sulfonate salt may be non-metallic such as a nitrogenous base. Nitrogen-based cations are derived from nitrogen-containing bases, which may be aliphatic, cycloaliphatic, or aromatic compounds. Examples of such nitrogen containing bases include ammonia, dimethylethanolamine, diethanolamine, triethanolamine, pyridine, morpholine, and piperidine. Because monomers containing the nitrogen-based sulfonate salts typically are not thermally stable at conditions required to make the polymers in the melt, the method for preparing sulfopolyesters containing nitrogen-based sulfonate salt groups is to disperse, dissipate, or dissolve the polymer containing the required amount of sulfonate group in the form of its alkali metal salt in water and then exchange the alkali metal cation for a nitrogen-based cation.

When a monovalent alkali metal ion is used as the cation of the sulfonate salt, the resulting sulfopolyester is completely dispersible in water with the rate of dispersion dependent on the content of sulfomonomer in the polymer, temperature of the water, surface area/thickness of the sulfopolyester, and so forth. Utilization of more than one counterion within a single polymer composition is possible and may offer a means to tailor or fine-tune the water-responsivity of the resulting article of manufacture. Examples of sulfomonomers residues include monomer residues where the sulfonate salt group is attached to an aromatic acid nucleus, such as, for example, benzene; naphthalene; diphenyl; oxydiphenyl; sulfonyldiphenyl; and methylenediphenyl or cycloaliphatic rings, such as, for example, cyclohexyl; cyclopentyl; cyclobutyl; cycloheptyl; and cyclooctyl. Other examples of sulfomonomer residues which may be used in the present invention are the metal sulfonate salt of sulfophthalic acid, sulfoterephthalic acid, sulfoisophthalic acid, or combinations thereof. Other examples of sulfomonomers which may be used are 5-sodiosulfoisophthalic acid and esters thereof. If the sulfomonomer residue is from 5-sodiosulfoisophthalic acid, typical sulfomonomer concentration ranges are 4 to 35 mole %, 8 to 30 mole %, and 8 to 25 mole %, based on the total moles of acid residues.

The sulfomonomers used in the preparation of the sulfopolyesters are known compounds and may be prepared using methods well known in the art. For example, sulfomonomers in which the sulfonate group is attached to an aromatic ring may be prepared by sulfonating the aromatic compound with oleum to obtain the corresponding sulfonic acid and followed by reaction with a metal oxide or base, for example, sodium acetate, to prepare the sulfonate salt. Procedures for preparation of various sulfomonomers are described, for example, in U.S. Pat. Nos. 3,779,993; 3,018,272; and 3,528,947, which are incorporated by reference in their entirety.

The water-dispersible sulfopolyester includes one or more diol residues which may include aliphatic, cycloaliphatic, and aralkyl glycols. The cycloaliphatic diols, for example, 1,3- and 1,4-cyclohexanedimethanol, may be present as their pure cis or trans isomers or as a mixture of cis and trans isomers. As used herein, the term “diol” is synonymous with the term “glycol” and means any dihydric alcohol. Examples of diols include, but are not limited to, ethylene glycol; diethylene glycol; triethylene glycol; polyethylene glycols; 1,3-propanediol; 2,4-dimethyl-2-ethylhexane-1,3-diol; 2,2-dimethyl-1,3-propanediol; 2-ethyl-2-butyl-1,3-propanediol; 2-ethyl-2-isobutyl-1,3-propane-diol; 1,3-butanediol; 1,4-butanediol; 1,5-pentanediol; 1,6-hexanediol; 2,2,4-trimethyl-1,6-hexanediol; thiodiethanol; 1,2-cyclohexanedimethanol; 1,3-cyclohexanedimethanol; 1,4-cyclohexanedimethanol; 2,2,4,4-tetramethyl-1,3-cyclobutanediol; p-xylylenediol, or combinations of one or more of these glycols.

The diol residues may include from 25 mole % to 100 mole %, based on the total diol residues, of residue of a poly(ethylene glycol) having a structure

H—(OCH₂—CH₂)ₙ—OH

wherein n is an integer in the range of 2 to 500. Non-limiting examples of lower molecular weight polyethylene glycols, e.g., wherein n is from 2 to 6, are diethylene glycol, triethylene glycol, and tetraethylene glycol. Examples of lower molecular weight glycols include diethylene glycol and triethylene glycol. Higher molecular weight polyethylene glycols (abbreviated herein as “PEG”), wherein n is from 7 to 500, include the commercially available products known under the designation CARBOWAX®, a product of Dow Chemical Company (formerly Union Carbide). Typically, PEGs are used in combination with other diols such as, for example, diethylene glycol or ethylene glycol. Based on the values of n, which range from greater than 6 to 500, the molecular weight may range from greater than 300 to 22,000 g/mol. The molecular weight and the mole % are inversely proportional to each other; specifically, as the molecular weight is increased, the mole % will be decreased in order to achieve a designated degree of hydrophilicity. For example, it is illustrative of this concept to consider that a PEG having a molecular weight of 1000 may constitute up to 10 mole % of the total diol, while a PEG having a molecular weight of 10,000 would typically be incorporated at a level of less than 1 mole % of the total diol.

Certain dimer, trimer, and tetramer diols may be formed in situ due to side reactions that may be controlled by varying the process conditions. For example, varying amounts of diethylene, triethylene, and tetraethylene glycols may be formed from ethylene glycol from an acid-catalyzed dehydration reaction which occurs readily when the polycondensation reaction is carried out under acidic conditions. The presence of buffer solutions, well-known to those skilled in the art, may be added to the reaction mixture to retard these side reactions. Additional compositional latitude is possible, however, if the buffer is omitted and the dimerization, trimerization, and tetramerization reactions are allowed to proceed.

The water-dispersible sulfopolyester may include from 0 to 25 mole %, based on the total repeating units, of residues of a branching monomer having 3 or more functional groups wherein the functional groups are hydroxyl, carboxyl, or a combination thereof. Non-limiting examples of branching monomers are 1,1,1-trimethylol propane, 1,1,1-trimethylolethane, glycerin, pentaerythritol, erythritol, threitol, dipentaerythritol, sorbitol, trimellitic anhydride, pyromellitic dianhydride, dimethylol propionic acid, or combinations thereof. Further examples of branching monomer concentration ranges are from 0 to 20 mole % and from 0 to 10 mole %. The presence of a branching monomer may result in a number of possible benefits to the water-dispersible-sulfopolyester, including but not limited to, the ability to tailor rheological, solubility, and tensile properties. For example, at a constant molecular weight, a branched sulfopolyester, compared to a linear analog, will also have a greater concentration of end groups that may facilitate post-polymerization crosslinking reactions. At high concentrations of branching agent, however, the sulfopolyester may be prone to gelation.

The water-dispersible sulfopolyester has a glass transition temperature, abbreviated herein as “Tg”, of at least 25° C. as measured on the dry polymer using standard techniques, such as differential scanning calorimetry (“DSC”), well known to persons skilled in the art. The Tg measurements of the sulfopolyesters of the present invention are conducted using a “dry polymer”, that is, a polymer sample in which adventitious or absorbed water is driven off by heating to polymer to a temperature of 200° C. and allowing the sample to return to room temperature. Typically, the sulfopolyester is dried in the DSC apparatus by conducting a first thermal scan in which the sample is heated to a temperature above the water vaporization temperature, holding the sample at that temperature until the vaporization of the water absorbed in the polymer is complete (as indicated by an a large, broad endotherm), cooling the sample to room temperature, and then conducting a second thermal scan to obtain the Tg measurement. Further examples of glass transition temperatures exhibited by the sulfopolyester are at least 30° C., at least 35° C., at least 40° C., at least 50° C., at least 60° C., at least 65° C., at least 80° C., at least 90° C. and at least 100° C. In embodiments of this invention, the glass transition temperature of the sulfopolyesters can range from 30° C. to 120° C., 35° C. to 100° C., 40° C. to 90° C., 45° C. to 80° C., and 50° C. to 70° C. Although other Tg's are possible, typical glass transition temperatures of the sulfopolyesters are 30° C., 48° C., 55° C., 65° C., 70° C., 75° C., 85° C., and 90° C.

The water dispersible sulfopolyesters used in this invention can comprise 1,4-cyclohexanedimethanol residues, wherein the sulfopolyester is at least one selected from the group consisting of:
(1) a water dispersible sulfopolyester comprising:

(a) residues of one or more dicarboxylic acids;

(b) at least 10 mole percent of residues of at least one sulfomonomer; and

(c) residues of two or more diols, wherein the diols comprise 1,4-cyclohexanedimethanol and diethylene glycol,

wherein the sulfopolyester exhibits a glass transition temperature of at least 57° C., wherein the sulfopolyester contains substantially equimolar proportions of acid moiety repeating units (100 mole percent) to hydroxy moiety repeating units (100 mole percent), and wherein all stated mole percentages are based on the total of all acid and hydroxy moiety repeating units being equal to 200 mole percent;
(2) a water dispersible sulfopolyester comprising:

(a) residues of isophthalic acid;

(b) residues of terephthalic acid;

(c) residues of at least one sulfomonomer;

(d) residues of 1,4-cyclohexanedimethanol; and

(e) residues of diethylene glycol,

wherein the sulfopolyester exhibits a glass transition temperature of at least 57° C., wherein the sulfopolyester contains substantially equimolar proportions of acid moiety repeating units (100 mole percent) to hydroxy moiety repeating units (100 mole percent), and wherein all stated mole percentages are based on the total of all acid and hydroxy moiety repeating units being equal to 200 mole percent; and
(3) a water dispersible sulfopolyester comprising:

(a) residues of one or more dicarboxylic acids;

(b) at least 10 mole percent of residues of at least one sulfomonomer; and

(c) residues of two or more diols, wherein the diols comprise 1,4-cyclohexanedimethanol and diethylene glycol,

wherein the sulfopolyester exhibits a glass transition temperature of at least 57° C., wherein the sulfopolyester contains substantially equimolar proportions of acid moiety repeating units (100 mole percent) to hydroxy moiety repeating units (100 mole percent)

These water dispersible sulfopolyesters comprising 1,4-cyclohexanedimethanol residues have a glass transition temperature of at least 57° C. and are dispersible in water at temperatures less than about 90° C. The novel sulfopolyesters are particularly useful for the production of multicomponent fibers where excellent removability is combined with blocking resistance.

In other embodiments, these sulfopolyesters comprising 1,4-cyclohexanedimethanol residues exhibit a glass transition temperature of at least 57° C., 58° C., 59° C., 60° C., 61° C., 62° C., 63° C., 64° C., 65° C., 66° C., 67° C., 68° C., 69° C., or 70° C. and/or less than 120° C., 115° C., 110° C., 105° C., 100° C., 95° C., or 90° C. The inherent viscosity can range from at least 0.1, 0.15, 0.2, 0.25, or 0.3 and/or less than 0.8, 0.7, 0.6, 0.5, or 0.45 dL/g.

In another embodiment, these sulfopolyesters comprising 1,4-cyclohexanedimethanol comprise two diols residues, wherein the diols consist of 1,4-cyclohexanedimethanol and diethylene glycol. In one embodiment, ethylene glycol is not utilized as a diol. The molar ratio of residues of diethylene glycol to the residues of 1,4-cyclohexanedimethanol can range from less than 1, less than 0.75, less than 0.5, or less than 0.25. The amount of residues of 1,4-cyclohexanedimethanol in the sulfopolyester can range from at least 20, 25, 30, 35, 40, 45, 50, 55, or 60 mole percent and/or not more than 99, 95, 90, 85, or 80 mole. The amount of sulfomonomer in these sulfopolyesters can range from at least 4, 5, 6, 7, 8, 8.5, 9, 9.5, 10, 11, 12, 13, or 14 mole percent and/or less than 40, 35, 30, 25, or 20 mole percent. In one embodiment of the invention, the sulfomonomer is sulfoisophthalic acid. In another embodiment of the invention, the sulfopolyester comprises residues of one or more dicarboxylic acids derived from terephthalic acid, isophthalic acid, or combinations thereof.

In another embodiment, these sulfopolyesters comprising 1,4-cyclohexanedimethanol residues can form an aqueous dispersion comprising at least 1, 1.5, 2, 2.5, 3, 3.5, 4, 4.5, or 5 weight percent of the sulfopolyester when the sulfopolyester is added to pure water at 90° C. under constant agitation for at least 5 minutes.

In another embodiment of this invention, the sulfopolyester comprises ethylene glycol and diethylene glycol residues. These sulfopolyesters are selected from the group consisting of:
(1) a sulfopolyester comprising:
   (a) residues of one or more dicarboxylic acids;
   (b) at least 10 mole percent of residues of at least one sulfomonomer; and
   (c) residues of two or more diols, wherein the diols comprise ethylene glycol and diethylene glycol,
      wherein the sulfopolyester exhibits a glass transition temperature of at least 58° C., wherein the sulfopolyester comprises a diethylene glycol residue to ethylene glycol residue molar ratio of less than 0.65, wherein the sulfopolyester contains substantially equimolar proportions of acid moiety repeating units (100 mole percent) to hydroxy moiety repeating units (100 mole percent), and wherein all stated mole percentages are based on the total of all acid and hydroxy moiety repeating units being equal to 200 mole percent; and 2) an amorphous sulfopolyester comprising:

(a) residues of isophthalic acid;

(b) residues of terephthalic acid;

(c) residues of at least one sulfomonomer;

(d) residues of ethylene glycol; and

(e) residues of diethylene glycol,

wherein the amorphous sulfopolyester exhibits a glass transition temperature of at least 58° C., wherein the amorphous sulfopolyester contains substantially equimolar proportions of acid moiety repeating units (100 mole percent) to hydroxy moiety repeating units (100 mole percent), and wherein all stated mole percentages are based on the total of all acid and hydroxy moiety repeating units being equal to 200 mole percent.

These sulfopolyesters comprising ethylene glycol and diethylene glycol residues have a glass transition temperature of at least 58° C. and are dispersible in water at temperatures less than about 90° C. These sulfopolyesters are particularly useful for the production of multicomponent fibers where excellent removability is combined with blocking resistance. In other embodiments of the invention, these sulfopolyesters exhibit a glass transition temperature of at least 59° C., 60° C., 61° C., 62° C., 63° C., 64° C., 65° C., 66° C., 67° C., 68° C., 69° C., or 70° C. and/or less than 120° C., 115° C., 110° C., 105° C., 100° C., 95° C., or 90° C.

The diethylene glycol residue to ethylene glycol residue molar ratio can range from less than 0.65, 0.6, 0.55, 0.5, 0.45, or 0.4. The inherent viscosity can range from at least 0.1, 0.15, 0.2, 0.25, or 0.3 and/or less than 0.8, 0.7, 0.6, 0.5, or 0.45 dL/g. In one embodiment, the sulfopolyester does not comprise any ethylene glycol residues. In addition, the sulfopolyester can comprises two diol residues, wherein the diol residues consist of ethylene glycol residues and diethylene glycol residues. The amount of ethylene glycol residues in the sulfopolyester can range from at least 20, 25, 30, 35, 40, 45, 50, 55, or 60 mole percent and/or not more than 99, 95, 90, 85, or 80 mole percent.

In another embodiment of the invention, the sulfopolyester can comprise residues of one or more dicarboxylic acids derived from terephthalic acid, isophthalic acid, or combinations thereof. The amount of terephthalic acid residues can range from at least 20, 25, 30, 35, 40, 45, 50, 55, or 60 mole percent and/or not more than 99, 95, 90, 85, or 80 mole percent of the residues of terephthalic acid. The amount of residues of isophthalic acid can range from at least 5, 10, 15, 20, 25, 30, 35, or 40 mole percent and/or not more than 99, 95, 90, 85, or 80 mole percent. In another embodiment, the sulfopolyester does not comprise any residues of isophthalic acid.

The sulfopolyester can comprise at least 10, 11, 12, 13, or 14 mole percent and/or less than 40, 35, 30, 25, or 20 mole percent of the sulfomonomer. In one embodiment, the sulfomonomer is sulfoisophthalic acid.

These sulfopolyesters comprising ethylene glycol and diethylene glycol residues can be amorphous. In addition, they may not exhibit a DSC melting point obtained with a dual heat scan with a heating profile from 0 to 280 ° C. at 10 ° C./min.

These sulfopolyesters can also form an aqueous dispersion comprising at least 1, 1.5, 2, 2.5, 3, 3.5, 4, 4.5, or 5 weight percent of the sulfopolyester when the sulfopolyester is added to pure water at 90° C. under constant agitation for at least 5 minutes.

In another embodiment of the invention, low dispersion viscosity sulfopolyesters can be utilized. The low dispersion viscosity sulfopolyester is at least one selected from the group consisting of:
(1) a sulfopolyester comprising:
   (a) residues of one or more dicarboxylic acids;
   (b) at least 4 mole percent and less than 8.5 mole percent of residues of at least one sulfomonomer; and
   (c) residues of one or more diols,
      wherein the sulfopolyester comprises a carboxylate ends to acid ends ratio of at least 0.6, wherein the sulfopolyester contains substantially equimolar proportions of acid moiety repeating units (100 mole percent) to hydroxy moiety repeating units (100 mole percent), and wherein all stated mole percentages are based on the total of all acid and hydroxy moiety repeating units being equal to 200 mole percent;
(2) a sulfopolyester comprising:
   (a) residues of one or more dicarboxylic acids;
   (b) greater than 8.5 mole percent of residues of at least one sulfomonomer; and
   (c) residues of one or more diols,
      wherein the sulfopolyester comprises a carboxylate ends to acid ends ratio of at least 0.35, wherein the amorphous sulfopolyester contains substantially equimolar proportions of acid moiety repeating units (100 mole percent) to hydroxy moiety repeating units (100 mole percent), and wherein all stated mole percentages are based on the total of all acid and hydroxy moiety repeating units being equal to 200 mole percent; and
(3) a sulfopolyester comprising:
   (a) residues of one or more dicarboxylic acids;
   (b) greater than 8.5 mole percent of residues of at least one sulfomonomer; and
   (c) residues of one or more diols,
      wherein the sulfopolyester comprises a carboxylate ends content of at least 12 μeq/g, wherein an aqueous dispersion comprising 25 weight percent of the sulfopolyester exhibits a dispersion viscosity of at least 30 cP and less than 100 cP at 22° C., wherein the sulfopolyester contains substantially equimolar proportions of acid moiety repeating units (100 mole percent) to hydroxy moiety repeating units (100 mole percent), and wherein all stated mole percentages are based on the total of all acid and hydroxy moiety repeating units being equal to 200 mole percent.

To determine the amount of carboxylate and acid ends of the sulfopolyester, a titration is conducted on a titrator (904 Titrando, Metrohm AG, US) equipped with Tiamo software and a pH electrode (DG116-solvent, Mettler Toledo, US) as sensing probe. The acid of the sample is titrated with tetrabutylammonium hydroxide solution (TBAOH, 0.1 N) in methanol. The base of the sample is titrated with hydrochloric acid (HCI, 0.1 N) in IPA. The total acid is titrated by TBAOH from the sample that has been protonated (titrated) by excess of HCl.

About 2.0 grams sample is weighted to a titration cell and stirred to dissolve in 30 ml N-methyl-2-pyrrolidone (NMP) at room temperature. 15 ml of dichloroethane (DCE) is added prior to titration. The sample solution is then titrated by TBAOH or HCI to the endpoint, which is determined by Tiamo software or manually. A blank of solvent is also titrated for both analyses.

The acid result is reported as mmol acid/g sample, which is calculated from the volume of TBAOH used at the titration endpoint, its normality, and weight of sample. The base result is reported as mmol base/g sample, which is calculated from the volume of HCI used at the titration endpoint, its normality, and weight of sample. The total acid is reported as mmol acid/g sample, which is calculated from the volume of TBAOH at the endpoint and volume of HCI added to the sample, their normality, and weight of sample.

The low dispersion viscosity sulfopolyester can have a carboxylate ends to acid ends ratio of at least 0.35, 0.4, 0.45, 0.5, 0.55, 0.6, 0.65, 0.7, 0.75, 0.8, 0.85, 0.9, 0.95, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4, 3.5, or 3.6 and/or less than 10, 9, 8, 7, or 6. The carboxylate ends content of the sulfopolyester can range from at least 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 and/or less than 200, 175, 150, 125, or 105 μeq/g. The acid ends content of the sulfopolyester can range from at least 1, 2, 3, 4, 5, 6, 7, 8, 9, 10, 11, 12, 13, 14, or 15 and/or less than 50, 45, 40, 35, 30, 25, or 20 μeq/g.

In one embodiment of the invention, the low dispersion viscosity sulfopolyesters have an inherent viscosity of at least 0.1, 0.15, 0.2, 0.25, or 0.3 and/or less than 0.8, 0.7, 0.6, 0.5, or 0.45 dL/g.

The amount of sulfomonomer residues contained in these sulfopolyester can range from at least 4, 5, 6, 7, 8, 8.5, 9, 9.5, or 10 mole percent and/or less than 25, 20, 19, 18, 17, 16, 15, 14, or 13 mole percent. In one embodiment, the sulfomonomer is a sulfoisophthalic acid.

In another embodiment of the invention, these sulfopolyesters comprise residues of one more dicarboxylic acids derived from terephthalic acid, isophthalic acid, or combinations thereof.

In yet another embodiment, these sulfopolyesters comprise residues of one or more diols derived from ethylene glycol, 1,4-cyclohexanedimethanol, diethylene glycol, or combinations thereof.

Aqueous dispersions comprising 20, 25, 30, 35, 40, 45, or 50 weight percent of these sulfopolyesters exhibit a dispersion viscosity of at least 10, 15, 20, 25, 30, 35, 40, 45, 50, 55, 60, 65, 70, 75, 80, 85, 90, or 95 cP and less than 1,000, 900, 800, 700, 600, 500, 400, 300, 200, or 100 cP at 22° C. Dispersion viscosity is measured at 400 rpm on a cone and plate rheometer using a #1 spindle at 30° C.

In embodiments, the starting material is composite material comprising fibers. The term “fiber” includes continuous fibers, staple fibers, short cut fiber, long fiber, and multicomponent fibers.

The term “continuous fibers” refers to fibers that are knotted together to produce a hydroentangled nonwoven fabric with high resistance to tearing when stretched in both directions. The term “staple fiber” refers to fiber cut into lengths of 25 mm to 60 mm. The term “short cut fiber” refers to fiber cut to lengths of 25 mm or less. The term “long fiber” refers to fibers cut to lengths greater 60 mm.

The term “multicomponent fiber” refers to a fiber prepared by melting the two or more fiber forming polymers in separate extruders and by directing the resulting multiple polymer flows into one spinneret with a plurality of distribution flow paths but spun together to form one fiber. Multicomponent fibers are also sometimes referred to as conjugate or bicomponent fibers. The polymers are arranged in substantially constantly positioned distinct segments or zones across the cross-section of the conjugate fibers and extend continuously along the length of the conjugate fibers. The configuration of such a multicomponent fiber may be, for example, a sheath/core arrangement wherein one polymer is surrounded by another or may be a side by side arrangement, a ribbon or stripped arrangement, a pie arrangement or an “islands-in-the-sea” arrangement. For example, a multicomponent fiber may be prepared by extruding the sulfopolyester and one or more water non-dispersible polymers separately through a spinneret having a shaped or engineered transverse geometry such as, for example, an “islands-in-the-sea” or segmented pie configuration. Multicomponent fibers, typically, are staple, monofilament or multifilament fibers that have a shaped or round cross-section. Most fiber forms are heatset. Multicomponent fibers can include the various antioxidants, pigments, and additives as described herein.

Optionally, prior to washing, the multicomponent fibers can be cut into short fibers. Short cut multicomponent fibers (SCMF) are multicomponent fibers that are cut to a length of 25 mm or less.

In embodiments, the composite material can contain less than 10 weight (wt)% of a pigment or filler, based on the total weight of the composite material.

The process of recovering the sulfopolyester described herein includes washing (FIG. 1, Wash Zone) the composite material composed of sulfopolyester at a temperature of less than 60° C. with a solvent composition (wash solvent) for a period of time to remove impurities on the surface of the composite material prior to opening of the fiber.

The term “impurities” or “contaminants” refers to any undesirable substance on the composite material surface. Impurities or contaminants can be naturally occurring or added during the process of recovering the sulfopolyester or added during manufacturing of the composite material including the sulfopolyester. Examples of ingredients added during the manufacturing process (additives) can include oil, slip agents, fillers, surface friction modifiers, light and heat stabilizers, extrusion aids, antistatic agents, colorants, dyes, pigments, fluorescent brighteners, antimicrobials, anticounterfeiting markers, antioxidants, hydrophobic and hydrophilic enhancers, viscosity modifiers, tougheners, adhesion promoters, and the like.

The term “solvent composition” or “wash solvent” refers to a composition including one or more solvents and other components. As an example, a solvent composition can include water, surfactant, and may include a small amount of organic solvent. Examples of surfactants include anionic surfactants, non-ionic surfactants, and the like. Examples of organic solvents include alcohols, acetone, ketones, ethers, esters, and the like. In embodiments, the solvent composition consists essentially of water or consists of water.

In embodiments, washing includes washing the composite material such that there is movement of wash solvent past the composite material, for example by mixing, agitating, and or flowing the wash solvent past the composite material, passing the composite material through wash solvent, and/or scrubbing the composite material with the wash solvent. Washing is performed with shear force. Machines suitable for washing the composite material include but are not limited to a washing machine, a plug flow conduit, a mixed tank, an agitated vessel, a vacuum belt filter, a vacuum drum filter, a batch vacuum filter, a moving belt. Washing can also be performed by passing the composite material through a vessel or trough containing wash solvent. The direction of composite material flow can be opposite to the direction of wash solvent flow allowing for continuous counter current washing. Washing residence time can range from 15 seconds to 15 minutes, 20 seconds to 12 minutes, 30 seconds to 10 minutes, 1 minute to 8 minutes, 1 minute to 5 minutes, or 1 minute to 3 minutes. In one embodiment, washing comprises separating the wash mother liquor from the solids in the wash zone. Examples of machines to implement the de-water step include, but are not limited, to centrifuges, filters, gravity drainage vessels, gravity drainage moving belts, and the like. Centrifuges include, but are not limited to, decanter centrifuge, perforated basket centrifuge, and/or pusher centrifuge. Filters include, but are not limited to, vacuum belt filter, pressure drum filter, vacuum nutsche filter and/or a rotary vacuum drum filter.

In embodiments, the wash temperature is between 20° C. and 60° C., between 30° C. and 60° C., between 40° C. and 60° C., or between 50° C. and 60° C.

Washing the composite material with wash solvent composition produces washed composite material and wash mother liquor.

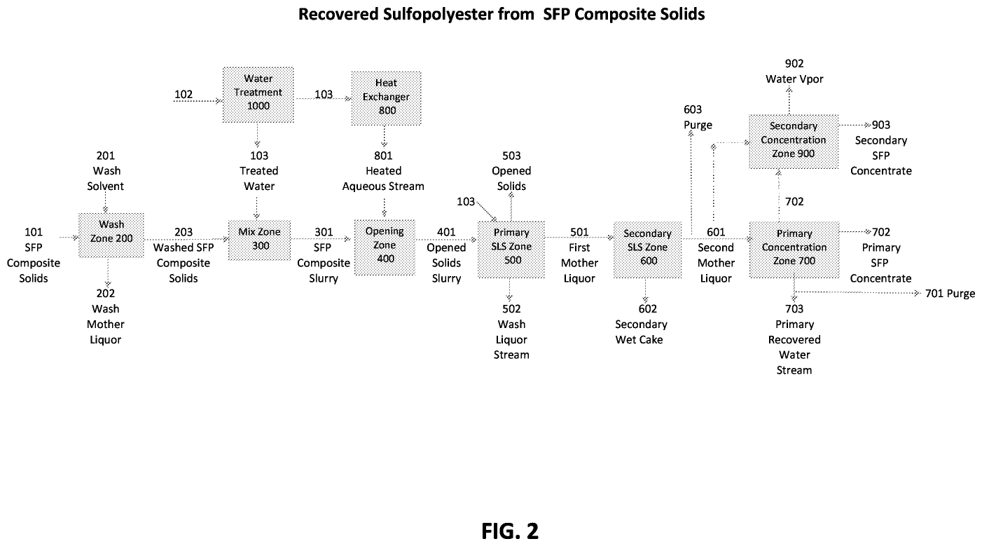

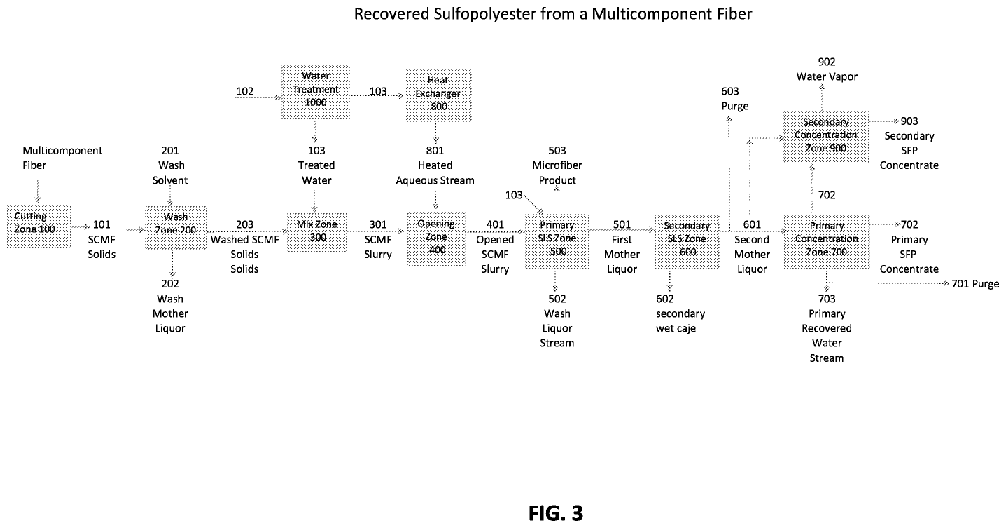

After the wash, the washed composite material is ready to be opened. In embodiments, prior to opening, the composite material is mixed with treated water. The term “treated water” refers to water that has been treated to remove multivalent cations, such as magnesium and calcium, so that it does not substantially inhibit the opening of the washed composite material. The term “treated water” in reference to opening the washed composite solid (FIG. 2) and SCMF (FIG. 3) and recovering sulfopolyester refers to the treated aqueous stream 103 described subsequently in this disclosure. Treated water is soft water and has a multivalent cation concentration ranging from 0 to 60 ppm.

The composite material is opened at a temperature of greater than 60° C. (FIG. 1, Opening Zone). The opening process comprises contacting the composite with water at a temperature of from 61° C. to 140° C., from 65° C. to 135° C., from 70° C. to 130° C., from 75° C. to 125° C., from 80° C. to 120° C., from 80° C. to 115 ° C., from 80° C. to 110° C., from 80° C. to 105° C., from 80° C. to 100° C. or from 80° C. to 90° C. Residence time in the opening zone can range from to 10 secs to 10 minutes, 20 secs to 8 minutes, 20 secs to 5 minutes, 20 secs to 4 minutes, 20 secs to 3 minutes, 20 secs to 2 minutes, or 20 secs to 1 minute.

The composite material is opened with shear force. In embodiments, the opening of the composite material includes mixing and/or agitating with shear force to open the composite material. During this period of opening, the composite material opens up, and sulfopolyester in the composite material is dissipated or dispersed in the hot water forming an aqueous dispersion comprising the sulfopolyester. Moreover, one or more non-dispersible polymers present is released and separated from the aqueous dispersion containing sulfopolyester (FIG. 1, Aqueous Dispersion & Non-Dispersible polymer).

The term “aqueous dispersion” refers to sulfopolyester that has been dispersed in water and no further process steps have been taken to increase the concentration of sulfopolyester. In embodiments, the first and second mother liquors described subsequently (FIG. 2 and FIG. 3) includes the aqueous dispersion of sulfopolyester.

Optionally, prior to recovering the sulfopolyester, the aqueous dispersion is filtered in a secondary filtration system or zone. Filtration removes any solids remaining in the aqueous dispersion, so that they do not interrupt the proper functioning of the equipment in the subsequent steps, for example clogging the recovery zone including the primary concentration zone. Equipment suitable for the secondary filtration zone include but is not limited to one or more of a pleated cartridge filter, leaf filter, a candle filter, batch pressure filter, batch vacuum filter, vacuum drum filter, continuous pressure filter, a strainer, and the like. Pre-filtration can also be performed with a centrifuge to remove any solid of 0.5 microns or greater.

Next, water is removed from the aqueous dispersion to recover the sulfopolyester (FIG. 1, Recovery Zone). Water can be removed from the aqueous dispersion by evaporation or by precipitation to produce recovered sulfopolyester. The term “recovered sulfopolyester” refers to sulfopolyester obtained by the process described herein including a washing step and can be in the form of a solid including some moisture or a concentrated sulfopolyester dispersion. The recovered sulfopolyester can also be in the form of a polymer melt.

Water may be evaporated from the aqueous dispersion by application of heat and/or vacuum to the dispersion. Apparatus for evaporating water include but are not limited to a thin film evaporator, climbing and falling film plate evaporator, rising film evaporator, falling film evaporator, natural circulation evaporator, a vented extruder, or List company Kneader Reactor, and the like. The List company Kneader Reactor comprises a vented extruder for evaporating water from the aqueous dispersion that is fed into the Kneader

Reactor and kneading elements for kneading the viscous concentrate formed after evaporation of the water to form a polymer melt.

Water can also be evaporated from the aqueous dispersion to obtain a sulfopolyester solid. The term “sulfopolyester solid” refers to sulfopolyester in solid form that includes some moisture. The moisture content of the sulfopolyester solid is less than 5 wt % relative to the total of wt of the solid. In embodiments, the moisture content is less than 4 wt %, 3 wt %, 2 wt %, 1 wt %, or 0.5 wt %, relative to the total wt of the solid.

In embodiments, water also can be efficiently removed by using a membrane filtration system to obtain recovered sulfopolyester in the form of a concentrated sulfopolyester dispersion. The term “membrane” or “filter” refers to a thin, film-like structure that separates two fluids. It acts as a selective barrier, allowing some particles or chemicals to pass through, but not others. A membrane is a layer of material that serves as a selective barrier between two phases and remains impermeable to specific particles, molecules, or substances when exposed to the action of a driving force. Some components are allowed passage by the membrane into a permeate stream, whereas others are retained by it and accumulate in the retentate stream.

Examples of membrane filtration systems include ultrafiltration system, a microfiltration system, a nanofiltration system, or reverse osmosis system. Nanofiltration is a cross-flow filtration technology which ranges between ultrafiltration and reverse osmosis. Nanofiltration membranes are typically rated by molecular weight cut-off (MWCO), which is defined as the smallest particle that will pass through a membrane to become permeate where retention of the larger particles is greater than 90%. Nanofiltration MWCO is typically less than 1000 atomic mass units (daltons). Ultrafiltration is a cross-flow filtration technology which ranges between nanofiltration and microfiltration. Ultrafiltration membranes are typically rated by MWCO. Ultrafiltration MWCO typically ranges from 10³ to 10⁶ atomic mass units (daltons).

The term “concentrated sulfopolyester dispersion” refers to an aqueous dispersion that has been further processed to remove water to increase the concentration of the sulfopolyester. The sulfopolyester in the concentrated dispersion is between 1 wt % to 40 wt %, between 1 wt % to 35 wt %, between 5 wt % to 30 wt %, between 10 wt % to 30 wt %, between 15 wt % to 30 wt %, between 20 wt % to 30 wt %, or between 25 wt % to 30 wt %, relative to the total weight of the concentrated sulfopolyester dispersion.

In embodiments, heat can be applied to the concentrated sulfopolyester dispersion to obtain a polymer melt. The polymer melt contains very little water and upon cooling forms a solid sulfopolyester.

In embodiments, the recovered sulfopolyester is in the form of a dispersion comprising recovered sulfopolyester and a solvent composition, and the dispersion comprises 0.01 wt % to 5 wt % impurities, relative to the total weight of the dispersion. The dispersion can be a concentrated recovered sulfopolyester dispersion. The dispersion can also be diluted with water at a volumetric ratio of 1:1, 1:2, 1:3, 1:4, 1:5, 1:10, 1:20, 1:30, 1:50, or 1:100.

In embodiments, the recovered sulfopolyester is a washed (pre-washed) recovered sulfopolyester dispersion comprising recovered sulfopolyester and a solvent composition; wherein the dispersion has an impurity level ranging from 0.01% to 5%, relative to the total weight of the dispersion. The term “washed recovered sulfopolyester” or “pre-washed recovered sulfopolyester” refers to sulfopolyester that has been recovered from material and the recovery process includes a washing (pre-washing) step prior to opening and/or mixing with treated water.

In embodiments, the amount of impurities in the dispersions described herein ranges from 0.1 wt % to 4.5 wt %, 0.1 wt % to 4.0 wt %, 0.1 wt % to 3.5 wt %, 0.1 wt % to 3.0 wt %, 0.1 wt % to 2.5 wt %, 0.1 wt % to 2.0 wt %, 0.1 wt % to 1.5 wt %, 0.1 wt % to 1.0 wt %, 0.1 wt % to 0.5 wt %, 0.1 wt % to 0.4 wt %, 0.1 wt % to 0.3 wt %, or 0.1 wt % to 0.2 wt %, relative to the total weight of the dispersion.

In embodiments, the recovered sulfopolyester is a washed (pre-washed) recovered sulfopolyester dispersion comprising recovered sulfopolyester and solvent composition, and the dispersion has a reduced impurity concentration of at least 80%, 82%, 85%, 87%, 90%, 92%, 95%, or 97%. or more compared to non-prewashed recovered sulfopolyester dispersion.

In embodiments, the recovered sulfopolyester is a washed (pre-washed) recovered sulfopolyester dispersion wherein the dispersion comprises substantially a two-phase system. The dispersion comprises mostly a water phase and a sulfopolyester phase. In embodiments, the dispersion can comprise impurities as described above. Depending on the impurity, for example if the impurity is oil, there may be another phase, containing a small amount of the impurity.

The recovered sulfopolyester described herein includes washed (or pre-washed) sulfopolyester in solid form comprising 0.01 wt % to 5 wt % impurities or reduced impurity concentration of at least 80% or more as compared to non-pre-washed recovered sulfopolyester dispersion.

The washed (pre-washed) recovered sulfopolyester dispersion comprises one or more of the following characteristics: a clear film quality as compared to non-prewash sulfopolyester dispersion; an average dispersion particle size ranging from 10 to 500 nm, 20 to 400 nm, 20 to 300 nm, 20 to 200 nm, or 20 to 100 nm; a particle distribution size of 1 to 1000 nm, 1 to 750 nm, 1 to 500 nm, 1 to 250 nm, or 1 to 100 nm; a solution viscosity of 50 to 1000 cp, 50 to 750 cp, 50 to 500 cp, 50 to 250 cp, or 50 to 100 cp; less than 2% cyclic oligomers; a molecular weight of 2 to 20 kDa, 3 to 15 kDa, or 4 to 10 kDa; and multivalent ion content of less than 60 ppm by weight, less than 40 ppm by weight, less than 20 ppm by weight, or less than 10 ppm by weight. Moreover, the washed (pre-washed) recovered sulfopolyester dispersion exhibits a clean drawdown film.

The washed (pre-washed) recovered sulfopolyester has a glass transition temperature (Tg) of 25° C. to 120° C., 30° C. to 120° C., 35° C. to 120° C., 40° C. to 120° C., 50° C. to 120° C., 60° C. to 120° C., 65° C. to 120° C., 70° C. to 120° C., 75° C. to 120° C., or 80° C. to 120° C.

The recovered sulfopolyester is both hydrophilic and hydrophobic. The recovered sulfopolyester comprises: (A) residues of one or more dicarboxylic acids; (B) 4 to 40 mole %, 4 to 40 mole %, 5 to 30 mole %, 6 to 20 mole %, 7 to 15 mole %, or 8 to 10 mole %, based on the total repeating units, of residues of at least one sulfomonomer comprising two functional groups and one or more sulfonate groups attached to an aromatic or cycloaliphatic ring wherein the functional groups are hydroxyl, carboxyl, or a combination thereof; (C) one or more diol residues ranging from 10 to 100% mole %, 10 to 90 mole %, 10 to 80 mole %, 15 to 75 mole %, 20 to 60 mole %, 20 to 55 mole %, 20 to 50 mole %, or 20 to 40 mole %, based on the total diol residues, is a poly(ethylene glycol) having the structure H(OCH₂CH₂)ₙOH, wherein n is an integer in the range of 2 to 500, 2 to 100, 2 to 75, 2 to 50, 2 to 25,2 to 20,2 to 15, 2 to 10,2 to 9, 2 to 8, 2 to 7, 2 to 6, 2 to 5, or 2 to 4; and 0 to 25 mole %, 0 to 20 mole %, 0 to 15 mole %, 0 to 10 mole %, 0 to 5 mole %, 0 to 4 mole %, 0 to 3 mole %, 0 to 2 mole %, or 0 to 1 mole %, based on the total repeating units, of residues of a branching monomer having 3 or more functional groups wherein the functional groups are hydroxyl, carboxyl, or a combination thereof.

Dicarboxylic acids include aliphatic dicarboxylic acids, alicyclic dicarboxylic acids, and/or aromatic dicarboxylic acids. Examples of such dicarboxylic acids include, but are not limited to, succinic acid, glutaric acid, adipic acid, azelaic acid, sebacic acid, fumaric acid, maleic acid, itaconic acid, 1,4-cyclohexanedicarboxylic acid, 2,6-naphthalene dicarboxylic acid, phthalic acid, terephthalic acid, and isophthalic acid.

Diols include aliphatic, alicyclic, and/or aralkyl glycols. Examples include ethylene glycol, diethylene glycol, triethylene glycol, polyethylene glycols, and polyalkylene glycols. Other suitable glycols include cycloaliphatic glycols having 6 to 20 carbon atoms and aliphatic glycols having 3 to 20 carbon atoms. Specific examples of such glycols are ethylene glycol, propylene glycol, 1,3-propanediol, 2,4-dimethyl-2-ethylhexane-1,3-diol, 2,2-dimethyl-1,3-propanediol, 2-ethyl-2-butyl-1,3-propanediol, 2-ethyl-2-isobutyl-1,3-propanediol, 1,3-butanediol, 1,4-butanediol, 1,5-pentanediol, 1,6-hexanediol, diethanol, 2,2,4-trimethyl-1,6-hexanedio-1 thiodiethanol, 1,2-cyclohexanedimethanol, 1,3-cyclohexanedimethanol, 1,4-cyclohexanedimethanol, 2,2,4,4-tetra-methyl-1,3-cyclobutanediol, and p-xylylenediol. The sulfopolyester can also comprise a mixture of glycols.

Diols also includes polyfunctional alcohols (polyols). Examples of polyols include neopentyl glycol; butylene glycol; 1,4-butanediol, hexylene glycol; 1,6-hexanediol; the polyglycols such as diethylene glycol or triethylene glycol and the like; the triols such as glycerine, trimetylol ethane, trimethylol propane and the like; and other higher functional alcohols such as pentaerythritol, sorbitol, mannitol, and the like.

In embodiments, the sulfomonomer comprising two functional groups and one or more sulfonate groups comprises a salt of a sulfoisophthalate moiety. The sulfoisophthalate moiety is derived from a sulfosiophthalic acid comprising a metal sulfonate group. The metal ion of the metal sulfonate group includes Na⁺, K⁺, or Li⁺. In embodiments, the recovered sulfopolyester comprises a salt of a sulfoisophthalate moiety. The salt of the sulfoisophthalate moiety can be derived from 5-sodiosulfoisophthalic acid or esters thereof.

The methods described herein advantageously tend not to degrade the sulfopolyester such that the recovered sulfopolyester exhibits an average molecular weight of 50% to 99%, 55% to 95%, 60% to 90%, 65% to 90%, 70% to 90%, 75% to 90%, 80% to 90%, 85% to 90% of at least of the molecular weight of the sulfopolyester present in the composite material.

In embodiments, each step of the process of recovering sulfopolyester described herein can be performed in a separate zone, as shown in FIG. 1, FIG. 2, and FIG. 3. Moreover, the mixing with the treated water and opening can be performed in the same zone, as discussed below. Further, the process, particularly the washing and opening, can be performed as a continuous flow process or as a batch process.

FIG. 2 shows a process for producing sulfopolyester concentrate streams 702 and/or 903 containing the recovered sulfopolyester. As shown in FIG. 2, the process comprises: (A) contacting sulfopolyester composite solids stream 101 with wash solvent composition 201 in a wash zone 200 to remove surface impurities and generating a wash mother liquor stream 202 and a washed sulfopolyester (SFP) composite solids stream 203; wherein the sulfopolyester composite solids in stream 203 comprise water-dispersible sulfopolyester and water non-dispersible polymer immiscible with the water-dispersible sulfopolyester; (B) contacting washed sulfopolyester composite solids stream 203 with treated water stream 103 in mix zone 300 to generate a sulfopolyester composite slurry stream 301; (C) contacting SFP composite slurry 301 with heated aqueous stream 801 in an opening zone 400 to remove a portion of the water-dispersible sulfopolyester to produce an opened solids slurry 401; wherein the heated aqueous stream 801 is at a temperature of greater than 60° C.; wherein the opened solids slurry 401 comprises water, non-dispersible polymer solids, and water-dispersible sulfopolyester; and (D) routing the opened solids slurry 401 to a primary solid liquid separation (SLS) zone 500 to produce the opened solids stream 503 and a first mother liquor stream 501; wherein the first mother liquor stream 501 comprises an aqueous dispersion comprising water-dispersible sulfopolyester; (E) routing a first mother liquor stream 501 to secondary SLS zone 600 to generate a second mother liquor stream 601; (F) routing a second mother liquor stream 601 to the primary concentration zone 700 to generate a primary recovered water stream 703 and primary SFP concentrate stream 702 comprising dispersed sulfopolyester and water; and (G) optionally routing a second mother liquor stream 601 and/or at least a portion of primary SFP concentrate stream 702 to a secondary concentration zone 900 to generate secondary SFP concentrate stream 903.

In embodiments, mix zone 300 and the opening zone 400 as shown in FIG. 2 can be combined into a single unit operation.

A treated aqueous stream 103 for use in the process can be produced by routing an aqueous stream 102 to an aqueous treatment zone 1000 to produce a treated aqueous stream 103. The aqueous stream comprises water and is treated to remove multivalent cations from the water. Removal of multivalent metal cations from the aqueous stream 102 is one function of the aqueous treatment zone 1000. In embodiments, the concentration of multivalent cations is less than 100 ppm by weight, less than 60 ppm by weight, less than 25 ppm by weight, less than 10 ppm by weight, or less than 5 ppm by weight. The temperature of stream 103 can range from ground water temperature to 40° C.

The treatment of the aqueous stream 102 in the aqueous treatment zone 1000 can be accomplished in any way known in the art. In embodiments, the water treatment zone 1000 comprises distillation equipment wherein water vapor is generated and condensed to produce the treated water (aqueous) stream 103. Water is routed to a reverse osmosis membrane separation system capable of separating multivalent metal cations from water to produce the treated water stream 103. In embodiments, water is routed to an ion exchange resin to generate the treated water stream 103 with acceptably low concentration of metal cations. Also, water can be routed to a commercial water softening apparatus to generate the treated water stream 103 with an acceptably low concentration of monovalent and multivalent metal cations. It is understood that any combinations of these water treatment options may be employed to achieve the required treated water characteristics.

The treated water stream 103 may be routed to any location in the process where it is needed. In embodiments, a portion of stream 103 is routed to a primary solid liquid separation (SLS) zone 500 to serve as a machine wash, filter media wash, and/or a wash for solids contained in the primary solid liquid separation zone 500.

In embodiments, at least a portion of the treated aqueous stream 103 is routed to heat exchanger zone 800 to produce a heated aqueous stream 801 and at least a portion of the treated aqueous stream 103 is routed to the mixing zone 300. Streams that can feed heat exchanger zone 800 include the treated aqueous stream 103, a portion of the primary recovered water stream 703, a portion of the first mother liquor stream 501, and a portion the second mother liquor stream 601. One function of heat exchanger zone 800 is to generate a heated aqueous stream 801 at a specific and controlled temperature.

Any equipment known in the art for controlling the temperature of stream 801 may be used including, but not limited to, any heat exchanger with steam used to provide a portion of the required energy, any heat exchanger with a heat transfer fluid used to provide a portion of the required energy, any heat exchanger with electrical heating elements used to provide a portion of the required energy, and any vessel or tank with direct steam injection wherein the steam condenses and the condensate mixes with the water feeds to heat exchanger zone 800.

The sulfopolyester composite stream 101 is routed to wash zone 200 to facilitate the washing of at least a portion of the impurities off the surface of the sulfopolyester composite stream solids. Impurities or contaminants can be naturally occurring or added during the process of recovering the sulfopolyester or added during manufacturing of the material including the sulfopolyester. Examples of ingredients added during the manufacturing process (additives) can include oil, slip agents, fillers, surface friction modifiers, light and heat stabilizers, extrusion aids, antistatic agents, colorants, dyes, pigments, fluorescent brighteners, antimicrobials, anticounterfeiting markers, antioxidants, hydrophobic and hydrophilic enhancers, viscosity modifiers, tougheners, adhesion promoters, and the like. It is desirable to remove such surface impurities prior to opening to prevent the impurities from contaminating second mother liquor stream 601 and concentrating in primary concentration zone 700 resulting in impurities concentrating in recovered sulfopolyester stream 702, which would render stream 702 unsuitable for certain end use applications. For example, oil present in the recovered sulfopolyester concentrate can result in poor film forming properties.

The temperature of wash solvent stream 201 can range from 20° C. and 60° C., 30° C. and 60° C., 40° C. and 60° C., or between 50° C. and 60° C.

The composition of wash solvent stream 201 comprises water. A small concentration surfactant and or organic solvent may also be present to help wash away certain impurities. For example, a surfactant is typically required to wash oils of SFP composite solids. In embodiments, the wash solvent (solvent composition) consists essentially of water or consists of water.

In embodiments, SFP composite solids stream 101 can be in the physical form of cut fiber, granular solids, discrete particles, a discrete solid object and the like. In embodiments, concentration of the SFP composite solids in the wash zone are controlled such that the mixture of wash solvent 201 and SFP composite solids stream 101 is a pumpable slurry. In other embodiments, the concentration of SFP composite solids in the wash zone are controlled such that sufficient wash solvent is present to wash a least a portion of impurities off the SFP composite solids. In yet other embodiments, it is desirable that the concentration of the SFP composite solids in the wash zone are controlled such that the mixture of wash solvent 201 and SFP composite solids stream 101 generate a non-settling mixture in a well agitated tank. The concentration of SFP composite solids in the wash zone can range from 0.1 wt % to 10 wt %, from 0.1 wt % to 8 wt %, from 0.1 wt % to 6 wt %, from 0.1 wt % to 4 wt %, from 0.1 wt % to 3 wt %, and from 0.1 wt % to 2 wt %, relative to the total combined weight of streams 101 and 201.

The functions of washing and dewatering of solids are present in wash zone 200. The washing function involves the contacting of wash solvent stream 201 and SFP composite solids stream 101 for enough time and shear force to transfer at least a portion of surface impurities into the continuous aqueous phase of the mixture. The residence time for the wash function can range from 15 seconds to 15 minutes, 20 seconds to 12 minutes, 30 seconds to 10 minutes, 1 minute to 8 minutes, 1 minute to 5 minutes, or 1 minute to 3 minutes. In embodiments, it is desirable that the wash mixture in wash zone 200 remain well mixed and substantially homogeneous not allowing many solids to settle during the wash function. This is accomplished with adequate agitation to keep solids suspended in the continuous phase during the wash function. The dewatering function follows the wash function and involves a solid-liquid separation to remove much of the continuous phase containing impurities from the solids. The extent of separation of solid and liquid in the dewatering function depends on the equipment used and the size of the solids present. It is desirable to maximize the amount of liquid mass separated from the wash mixture. Typical % moisture of washed SFP composite solids stream 203 can range from 10% solids to 85% solids, 20% solids to 85% solids, 30% solids to 85% solids, 40% solids to 85% solids, 50% solids to 85% solids, 10% solids to 75% solids, 20% solids to 75% solids, 30% solids to 75% solids, and 40% solids to 75% solids. In batch washing and dewatering it is understood that multiple, sequential wash and dewater steps may be required to obtain desired purity of washed SFP composite solids stream 203.

The two functions of washing and dewatering can be accomplished in the same unit operation or separate unit operations in both batch and continuous equipment. In embodiments, SFP composites are in the form of a continuous fiber, cloth, woven or non-woven article which can be washed by passing it through a vessel or trough containing wash solvent. In other embodiments, SFP composites are in the form of a continuous fiber, cloth, woven or non-woven article which can be washed by flowing wash solvent past the SFP composite solids. In embodiments, SFP composites are in the form of a continuous fiber, cloth, woven or non-woven article which can be washed by passing saturated steam through the article or a flooded wash on a vacuum belt or gravity belt filter. Examples of equipment suitable for batch washing include a batch agitated tank, batch agitated vessel, and the like. Examples of equipment suitable for continuous washing include any continuous stirred vessel capable of providing a substantially non-settling mixture and the desired residence time. Examples of equipment suitable for batch dewatering include, vacuum nutsche, pressure leaf filter, pressure candle filter, gravity draining belt filter, vacuum belt filter, vacuum drum filter, batch basket centrifuge, wash trough, and the like. Batch equipment capable of both the wash and dewater function include a batch agitated vessel with a perforated discharge to allow for solid liquid separation such as a false bottom reactor, a filter dryer, agitated nutsche vessel, and the like. Continuous solid-liquid separation equipment capable dewatering functions include but is not limited to rotary vacuum filter, vacuum belt filter, continuous pressure drum filter, and the like. Such continuous solid-liquid separation equipment also has short residence time wash capability and therefore provide both the wash and dewatering function if the residence time required for washing is ranges from 0.25 to 3 minutes. Multiple wash zones can be configured in these machines in either counter current or co-current flow with the solids.

In embodiments, SFP composite stream 101 is in the physical form of a woven article, a mat, a felt, a melt spun article, non-woven article, additive manufactured article, molded article, and the like. Contacting wash solvent 201 with SFP composite stream 101 does not form and slurry and the concentration of solids in the liquid is therefore not limited to that suitable for forming a slurry. Equipment must be selected that allows enough wash solvent contact time and shear force to allow for the removal of impurities from the solids surface into the wash mother liquor stream 202. This can be accomplished in simple agitated batch vessels with repeated wash and drain cycles until the solids are adequately washed. The wash and dewatering function can also be accomplished in continuous equipment such as a vacuum belt filter with a flooded displacement wash or washes, a perforated covey belt comprising a wash zone and dewater zone, and the like. Wash residence time for a flooded displacement wash ranges from 0.5 minutes to 5 minutes, 0.5 minutes to 4 minutes, 0.5 minutes to 3 minutes.

Washed SFP composite solids stream 203 and treated water stream 103 are routed to mix zone 300 where the substantially dewatered solids in stream 203 are re-slurred to form SFP composite stream 301. Equipment suitable for mix zone 300 include batch mix vessels or continuous mix vessels. There is no limitation on residence time. Agitation in tanks must be enough to generate a substantially homogenous slurry that is pumpable. The percent solids of SFP composite slurry stream 301 ranges from 0.1 wt % to 10 wt %, from 0.1 wt % to 8 wt %, from 0.1 wt % to 6 wt %, from 0.1 wt % to 4 wt %, from 0.1 wt % to 3 wt %, and from 0.1 wt % to 2 wt %.

SFP composite slurry stream 301 and a portion of the heated treated aqueous stream 801 are routed to opening zone 400 to generate opened solids slurry 401. One function of opening zone 400 is to separate the water-dispersible polymer from the SFP composite solids such that at least a portion of the water non-dispersible polymer separates from water-dispersible polymer and become suspended in the opened solids slurry 401 comprising non-water-dispersible solids and dispersed sulfopolyester. In embodiments, from 50 wt % to 100 wt % of water non-dispersible polymer fibers contained in the SFP composite solids 301 becomes suspended in the opened solids slurry 401 as water non-dispersible polymer and is no longer a part of the SFP composite solids. In embodiments, from 75 wt % to 100 wt %, from 90 wt % to 100 wt %, or from 95 wt % to 100 wt % of the water non-dispersible polymer contained in the SFP composite solids slurry stream 301 becomes suspended in the opened solids slurry 401 as water non-dispersible polymer solids and are no longer a part of SFP composite solids.

Residence time, temperature, and shear forces in the opening zone 400 influence the extent of separation of the water-dispersible sulfopolyester from the SFP composite solids. The conditions influencing the opening process of the composite solids in opening zone 400 include residence time, slurry temperature, and shear forces where the ranges of water temperature, residence time in opening zone 400, and amount of applied shear force are dictated by the need to separate the water-dispersible sulfopolyester from the starting composite solid to a sufficient degree to result in water non-dispersible polymer becoming separated and suspended in the continuous aqueous phase of the opened solids slurry 401.

The temperature of the opening zone 400 can range from between 61° C. to 140° C., from 65° C. to 135° C., from 70° C. to 130° C., from 75° C. to 125° C., from 80° C. to 120° C., from 80° C. to 115° C., from 80° C. to 110° C., from 80° C. to 105° C., from 80° C. to 100° C., or from 80° C. to 90° C. The residence time in the opening zone 400 can range from 10 seconds to 10 minutes, 20 seconds to 8 minutes, 20 seconds to 5 minutes, 20 seconds to 4 minutes, 20 seconds to 3 minutes, 20 seconds to 2 minutes, or 20 seconds to 1 minute.

Sufficient mixing is maintained in the opening zone 400 to maintain a suspension of water non-dispersible polymers such that the settling is minimal. In embodiments, the mass per unit time of water non-dispersible polymer settling in the opening zone 400 is less than 5% of the mass per unit time of water non-dispersible polymer entering the zone 400, less than 3% of the mass per unit time of cut water non-dispersible polymer entering zone 400, or less than 1% of the mass per unit time of cut water non-dispersible polymer entering the opening zone 400.

Composite solid opening in the opening zone 400 may be accomplished with any equipment capable of allowing for acceptable ranges of residence time, temperature, and mixing. Examples of suitable equipment include, but are not limited to, an agitated batch tank, a continuous stirred tank reactor, and a pipe with sufficient flow to minimize solids from settling out of the slurry. One example of a unit operation to accomplish opening of the washed composite solids in continuous equipment is a vacuum belt filter with a flooded displacement wash or washes, a perforated covey belt comprising a wash zone and dewater zone, and the like. Another example of a unit operation to accomplish opening of the composite solid in opening zone 400 is a plug flow reactor where the SFP composite slurry 301 is routed to zone 400 plug flow device, typically a circular pipe or conduit. The residence time of material in a plug flow device is calculated by dividing the filled volume within the device by the volumetric flow rate in the device. Velocity of the mass in the device is defined by the cross-sectional area of the flow channel divided by the volumetric flow of the liquid through the device.

The opening zone 400 can comprise a pipe or conduit wherein the velocity of mass flowing in the pipe can range from 0.1 ft/second to 20 feet/second, from 0.2 ft/sec to 10 ft/sec, or from 0.5 ft/sec to 5 ft/sec. For flow of a fluid or slurry in a pipe or conduit, the Reynolds number Re is a dimensionless number useful for describing the turbulence or motion of fluid eddy currents that are irregular with respect both to direction and time. For flow in a pipe or tube, the Reynolds number (Re) is defined as:

$$Re = \frac{p v {D}_{H}}{μ} = \frac{v {D}_{H}}{v} = \frac{Q {D}_{H}}{v A}$$

where:
D_{H} is the hydraulic diameter of the pipe; L, (m);
Q is the volumetric flow rate (m³/s);
A is the pipe cross-sectional area (m²).
V is the mean velocity of the object relative to the fluid (SI units: m/s);
μ is the dynamic viscosity of the fluid (Pa·s or N·s/m² or kg/(m·s));
v is the kinematic viscosity (v=μ/ρ)(m²/s)
ρ is the density of the fluid (kg/m³).
   For flow in a pipe of diameter D, experimental observations show that for fully developed flow, laminar flow occurs when Re<2000, and turbulent flow occurs when Re>4000. In the interval between 2300 and 4000, laminar and turbulent flows are possible (“transition” flows), depending on other factors, such as, pipe roughness and flow uniformity.

Opening zone 400 can comprise a pipe or conduit to facilitate the opening process, and the Reynolds number for flow through the pipe or conduit in composite solid opening zone 400 can range from 2,100 to 6,000, from 3,000 to 6,000, or from 3,500 to 6,000. In embodiments, opening zone 400 can comprise a pipe or conduit to facilitate the opening process, and the Reynolds number for flow through the pipe or conduit is at least 2,500, at least 3,500, or at least 4,000.

Opening zone 400 can be achieved in a pipe or conduit containing a mixing device inserted within the pipe or conduit. The device can comprise an in-line mixing device. The in-line mixing device can be a static mixer with no moving parts. In embodiments, the in-line mixing device comprises moving parts. Without being limiting, such an element is a mechanical device for the purpose of imparting more mixing energy to the heated SFP composite slurry 301 than achieved by the flow through the pipe. The device can be inserted at the beginning of the pipe section used as the fiber opening zone, at the end of the pipe section, or at any location within the pipe flow path.

The opened solids slurry stream 401 comprising water non-dispersible polymer, water, and water-dispersible sulfopolyester can be routed to a primary solid liquid separation zone 500 to generate an opened solids product stream 503 comprising opened solid, a first mother liquor stream 501, and a wash liquor stream 502. In embodiment, the first mother liquor stream 501 comprises an aqueous dispersion of sulfopolyester.

The wt % of solids in the opened solids slurry 401 can range from 0.1 wt % to 20 wt %, from 0.3 wt % to 10 wt %, from 0.3 wt % to 5 wt %, or from 0.3 wt % to 2.5 wt %.

Separation of the opened solids product stream 503 from the opened solids slurry 401 can be accomplished by any method known in the art. In embodiments, wash stream 103 comprising water is routed to the primary solid liquid separation zone 500. Wash stream 103 can be used to wash the opened solids in the primary solid liquid separation (SLS) zone 500 and/or the filter cloth media in the primary solid liquid separation zone 500 to generate wash liquor stream 502. A portion up to 100 wt % of wash liquor stream 502 can be combined with the opened solids slurry 401 prior to entering the primary solid liquid separation zone 500. A portion up to 100 wt % of wash liquor stream 502 can be routed to a second SLS zone 600. Wash liquor stream 502 can contain some composite solids. The grams of composite solids mass breaking though the filter media with openings up to 2000 microns in the primary solid liquid separation zone 500 ranges from 1 to 2 grams/cm² of filter area. In embodiments, the filter openings in the filter media in the primary solid liquid separation zone 500 can range from 43 microns to 3000 microns, from 100 microns to 2000 microns, or from 500 microns to 2000 microns.

Separation in the primary SLS zone 500 may be accomplished by a single or multiple solid liquid separation devices, for example, by a solid liquid separation device or devices operated in batch and or continuous fashion. Suitable solid liquid separation devices in the primary solid liquid separation zone 500 can include, but is not limited to, at least one of the following: perforated basket centrifuges, continuous vacuum belt filters, batch vacuum nutsche filters, batch perforated settling tanks, twin wire dewatering devices, continuous horizontal belt filters with a compressive zone, non-vibrating inclined screen devices with wedge wire filter media, continuous vacuum drum filters, dewatering conveyor belts, decanter centrifuge, batch centrifuges, and the like.

In embodiments, the primary solid liquid separation zone 500 comprises a twin wire dewatering device wherein the opened solids slurry 401 is routed to a tapering gap between a pair of traveling filter cloths traveling in the same direction. In the first zone of the twin wire dewatering device, water drains from the opened solids slurry 401 due to gravity and the very narrowing gap between the two moving filter cloths. In a downstream zone of the twin wire dewatering device, the two filter cloths and the opened solids mass between the two filter cloths are compressed one or more times to mechanically reduce moisture in the opened solids mass. Mechanical dewatering can be accomplished by passing the two filter cloths and contained open solids mass through at least one set of rollers that exert a compressive force on the two filter cloths and opened solids mass. Mechanical dewatering can also be accomplished by passing the two filter cloths and opened solids mass between at least one set of pressure rollers.

The force exerted by mechanical dewatering for each set of pressure rollers can range from 25 to 300 lbs/linear inch of filter media width, from 50 to 200 lbs/linear inch of filter media width, or from 70 to 125 lbs/linear inch of filter media width. The opened solid product stream 503 is discharged from the twin wire water dewatering device as the two filter cloths separate and diverge at the solids discharge zone of the device. The thickness of the discharged opened solids mass can range from 0.2 inches to 1.5 inches, from 0.3 inches to 1.25 inches, or from 0.4 inches to 1 inch. In embodiments, a wash stream comprising water is continuously applied to the filter media. In embodiments, a wash stream comprising water is periodically applied to the filter media.

The primary SLS zone 500 can include a belt filter device comprising a gravity drainage zone and a pressure dewatering zone. Opened solids slurry 401 is routed to a tapering gap between a pair of moving filter cloths traveling in the same direction which first pass through a gravity drainage zone and then pass through a pressure dewatering zone or press zone comprising a convoluted arrangement of rollers. As the belts are fed through the rollers, water is squeezed out of the solids. When the belts pass through the final pair of rollers in the process, the filter cloths are separated and the solids exit the belt filter device.

In embodiments, at least a portion of the water contained in the first mother liquor stream 501 comprising water and water-dispersible sulfopolyester polymer is recovered and recycled. The first mother liquor stream 501 can be recycled to the primary solid liquid separation zone 500. Depending on the efficiency of the primary liquid separation zone in the removal of the water non-dispersible polymer, the first mother liquid stream 501 can be recycled to the fiber opening zone 400, or the heat exchanger zone 800 prior to being routed to Zone 400. The first mother liquor stream 501 can contain a small amount of solids comprising water non-dispersible polymer due to breakthrough and wash, for example machine wash. The grams of water non-dispersible polymer mass breaking though filter media in the primary solid liquid separation zone with openings up to 2000 microns ranges from 1 to 2 grams/cm² of filter area. It is desirable to minimize the water non-dispersible polymer solids in the first mother liquor stream 501 prior to routing stream 501 to the primary concentration zone 700 and heat exchange zone 800 where water non-dispersible polymer solids can collect and accumulate in the zones having a negative impact on their function.

A SLS zone 600 can serve to remove at least a portion of water non-dispersible polymer solids present in the first mother liquor stream 501 to generate a secondary wet cake stream 602 comprising water non-dispersible and a second mother liquor stream 601 comprising water and water-dispersible sulfopolyester.

In embodiments, the second mother liquor stream 601 can be routed to a primary concentration zone 700 and or heat exchanger zone 800 wherein the wt % of the second mother liquor stream 601 routed to the primary concentration zone 700 can range from 0% to 100% with the balance of the stream being routed to heat exchanger zone 800. The second mother liquor stream 601 can be recycled to opening zone 400, or the heat exchanger zone 800 prior to being routed to zone 400. The amount of the water-dispersible sulfopolyester in the second mother liquor stream routed to the fiber opening zone 400 can range from 0.01 wt % to 7 wt %, based on the wt % of the second mother liquor stream, or from 0.1 wt % to 7 wt %, from 0.2 wt % to 5 wt %, or from 0.3 wt % to 3 wt %.

Any portion of the second mother liquor 601 routed to primary concentration zone is subjected to a separation process to generate a primary recovered water stream 703 and a primary polymer concentrate stream 702 enriched in water-dispersible sulfopolyester wherein the wt % of water-dispersible sulfopolyester in the primary polymer concentrate stream 702 can range between 1 wt % to 40 wt %, between 1 wt % to 35 wt %, between 5 wt % to 30 wt %, between 10 wt % to 30 wt %, between 15 wt % to 30 wt %, between 20 wt % to 30 wt %, or between 25 wt % to 30 wt %, relative to the total weight of the concentrated sulfopolyester dispersion. Primary SFP concentrate stream 702 constitutes a recovery of 75% to 99.9%, 75% to 99%, 80% to 98%, 85% to 97%, 90% to 96%, or 91% to 95% of the sulfopolyester in the composite solids.

The primary recovered water stream 703 can be recycled to opening zone 400, or the heat exchanger zone 800 prior to being routed to zone 400. The amount of the water-dispersible sulfopolyester in the second mother liquor stream routed to the fiber opening zone 400 can range from 0.01 wt % to 7 wt %, based on the wt % of the second mother liquor stream, or from 0.1 wt % to 7 wt %, from 0.2 wt % to 5 wt %, or from 0.3 wt % to 3 wt %.

Water can be removed from the second mother liquor stream 601 by any method known in the art in the primary concentration zone 700 to produce the primary SFP concentrate stream 702. In embodiments, removal of water involves an evaporative process by boiling water away in batch or continuous evaporative equipment. For example, one or more thin film evaporators can be used for this application. Membrane technology comprising ultrafiltration, microfiltration, nanofiltration media can be used to generate the primary SFP concentrate stream 702. In embodiments, a process comprising extraction equipment may be used to extract water-dispersible polymer from the second mother liquor stream 601 and generate the primary SFP concentrate stream 702. It is understood that any combination of evaporation, membrane, and extraction steps may be used to separate the water-dispersible sulfopolyester from the second mother liquor stream 601 and generate the primary polymer concentrate stream 702. The primary SFP concentration stream 702 may then exit the process.

Filtration systems including ultrafiltration, microfiltration, and nanofiltration systems, can be used to generate the primary SFP concentrate stream 702. In embodiments, a process comprising extraction equipment may be used to extract water-dispersible polymer from the second mother liquor stream 601 and generate the primary SFP concentrate stream 702. It is understood than any combination of evaporation, membrane, and extraction steps may be used to separate the water-dispersible sulfopolyester from the second mother liquor stream 601 and generate the primary polymer concentrate stream 702. The primary SFP concentration stream 702 may then exit the process.

The membrane filtration for concentration of sulfopolyester can be accomplished in a batch or continuous fashion. In embodiments, the membrane filtration zone comprises at least one ultrafiltration membrane in a batch operation. An aqueous dispersion is routed to the sulfopolyester concentration zone comprising at least one nanofiltration, ultrafiltration, or microfiltration membrane. Primary SFP concentrate stream 702 can be recycled to feed primary concentration zone 700 until the desired sulfopolyester concentration is reached in stream 702.

Membrane filtration for concentration of sulfopolyester can be accomplished in a batch or continuous fashion. In one embodiment, primary concentration zone 600 comprises at least one ultrafiltration, microfiltration, or nanofiltration membrane in a batch operation. In another embodiment, primary concentration zone 600 comprises at least one ultrafiltration, microfiltration, or nanofiltration membrane in a continuous operation.

In embodiments, primary concentration zone 700 is accomplished in a continuous membrane filtration system that comprises one or more membrane units in series relative to the flow path. In embodiments, each membrane unit comprises at least one nanofiltration, microfiltration, or ultrafiltration membrane and may contain multiple nanofiltration, microfiltration, or ultrafiltration membranes in parallel to achieve the desired membrane filtration area needed to accommodate the feed rate of the stream 601. In embodiments, primary concentration zone 700 may comprise membranes other than ultrafiltration membranes. For example, zone 700 can comprise two or more membrane units in series. Multiple membranes may be utilized in zone 700, and these membranes can be operated at different pressures.

In embodiments, the primary polymer concentrate stream 702 can be routed to a secondary concentration zone 900 to generate a melted polymer stream 903 comprising water-dispersible sulfopolyester, wherein the wt % of polymer ranges from 95% to 100% and a vapor stream 902 comprising water. In embodiments, the 903 comprises water-dispersible sulfopolyester. Equipment suitable for the secondary concentration zone 900 includes any equipment known in the art capable of being fed an aqueous dispersion of water-dispersible polymer and generating a 95% to 100% water-dispersible polymer stream 903. In embodiments, feeding an aqueous dispersion of water-dispersible sulfopolyester polymer to a secondary concentration zone 902. The temperature of feed stream is typically below 100° C.

The secondary concentration zone 900 comprises at least one device characterized by a jacketed tubular shell containing a rotating convey screw wherein the convey screw is heated with a heat transfer fluid or steam and comprises both convey and high shear mixing elements. The jacket or shell is vented to allow for vapor to escape. The shell jacket may be zoned to allow for different temperature set points along the length of the device. During continuous operation, the primary polymer concentrate stream 702 comprises an aqueous dispersion of water-dispersible sulfopolyester and is continuously fed to the secondary concentration zone 900. Within the device, during steady state, mass exists in at least three distinct and different forms. Mass first exists in the device as an aqueous dispersion of water-dispersible sulfopolyester polymer. As the aqueous dispersion of sulfopolyester polymer moves through the device, water is evaporated due to the heat of the jacket and internal screw. When sufficient water is evaporated, the mass becomes a second form comprising a viscous plug at a temperature less than the melt temperature of the sulfopolyester polymer. The aqueous dispersion cannot flow past this viscous plug and is confined to the first aqueous dispersion zone of the device. Due to the heat of the jacket, heat of the internally heated screw, and the heat due to mixing shear forces of this high viscosity plug mass, substantially all the water present at this location evaporates, and the temperature rises until the melt temperature of the sulfopolyester is reached resulting in the third and final physical forms of mass in the device comprising melted sulfopolyester polymer. The melted sulfopolyester polymer then exits the device through an extrusion dye and is typically cooled and cut into pellets by any fashion know in the art. It is understood that the device for secondary concentration zone 900 described above may also be operated in batch fashion wherein the three physical forms of mass described above occur throughout the length of the device but at different times in sequential order beginning with the aqueous dispersion, the viscous plug mass, and finally the sulfopolyester melt.

In embodiments, water vapor stream 902 generated in the secondary concentration zone 900 may be condensed and routed to heat exchanger zone 800, discarded, and/or routed to wash stream 103. In embodiments, water vapor stream 902 comprising water vapor can be routed to heat exchanger zone 800 to provide at least part of the energy required for generating the required temperature for stream 801. The melted polymer stream 903 comprising water-dispersible polymer comprising sulfopolyester in the melt phase can be cooled to a solid and chopped into pellets by any method known in the art.

Impurities can enter the process and concentrated in water recovered and recycled. One or more purge streams (603 and 701) can be utilized to control the concentration of impurities in the second mother liquor 601 and primary recovered water stream 701 to acceptable levels. In embodiments, a portion of the second mother liquor stream 601 can be isolated and purged from the process. In embodiments, a portion of the primary recovered water stream 701 can be isolated and purged from the process.

In embodiments, when the SFP composite solids are present as a cut fiber (FIG. 3), the diameter of the starting cut multicomponent fiber in stream 101 impacts the extent of separation of the water-dispersible sulfopolyester from the cut multicomponent fiber in the fiber opening zone 400. Typical short cut multicomponent fiber types generally have a diameter in the of less than 25 microns. Some cut multicomponent fibers can have larger starting diameters. The time required to separate a desired amount of water-dispersible sulfopolyester from the cut multicomponent fiber increases as the diameter of the cut multicomponent fiber increases.

Any equipment known in the art may be used to cut multicomponent fiber to generate cut multicomponent fiber stream 101 (FIG. 3). In embodiments, the length of the cut fibers in the cut multicomponent fiber stream 101 is less than 25 mm. In embodiments, the length of cut fibers in the cut multicomponent fiber stream 101 is less than 25 mm, less than 20 mm, less than 15 mm, less than 10 mm, or less than 5 mm, and greater than 2.5 mm.

In embodiments, the process for recovering sulfopolyester from multicomponent fibers is shown in FIG. 3. As shown, the process comprises producing a microfiber product stream 503, which comprises: (A) cutting multicomponent fibers comprising sulfopolyester into short fibers having a length of less than 25 millimeters, wherein the multicomponent fibers comprise water-dispersible sulfopolyester and water non-dispersible polymer immiscible with the water-dispersible sulfopolyester; (B) contacting the short cut multicomponent fiber (SCMF) solids stream 101 with wash solvent 201 in a wash zone 200 to remove surface impurities and generating a wash mother liquor stream 202 and a washed SCMF solids stream 203; (C) contacting washed SCMF solids stream 203 with treated water stream 103 in mix zone 300 to generate a SCMF slurry stream 301; (D) contacting SCMF slurry 301 with heated aqueous stream 801 in a fiber opening zone 400 to remove a portion of the water-dispersible sulfopolyester to produce an opened SCMF slurry 401; wherein the heated aqueous stream 801 is at a temperature of greater than 60° C.; wherein the opened SCMF slurry 401 comprises water, non-dispersible polymer solids, and water-dispersible sulfopolyester; and (E) routing the opened SCMF slurry 401 to a primary solid liquid separation (SLS) zone 500 to produce the microfiber product stream 503 and a first mother liquor stream 501; wherein the first mother liquor stream 501 comprises an aqueous dispersion comprising water-dispersible sulfopolyester; (F) routing a first mother liquor stream 501 to a secondary SLS zone 600 to generate a second mother liquor stream; (G) routing a second mother liquor stream to the primary concentration zone to generate primary recovered water stream 703 and primary SFP concentrate stream 702 comprising dispersed sulfopolyester and water; and (H) optionally routing a second mother liquor stream 601 and/or at least a portion of primary SFP concentrate stream 702 to a secondary concentration zone 900 to generate secondary SFP concentrate stream 903.

In embodiments, mix zone 300, and opening zone 400 can be combined and accomplished in a single unit operation. The short cut multicomponent fiber stream 101 is routed directly to a single unit operation where it is mixed with the heated aqueous stream 801 within fiber opening zone 400. For example, a process where the opening of the cut multicomponent fibers is accomplished in a mixing device wherein cut multicomponent fiber stream 101 and the heated aqueous stream 801 are added directly to the in the fiber opening zone 400. A mixing device including but not limited, batch mixing device, continuous mixing device, continuous stirred tank reactor (CSTR), plug flow conduit, and the like. The fiber opening zone can comprise at least one mix tank. The combined functions of zones 200, 300 and 400 may be accomplished in a continuous stirred tank reactor. In embodiments, the combined functions of zones 200, 300 and 400 may be accomplished in any batch or continuous mixing device capable of achieving the functional requirements of residence time, temperature, and mixing shear forces required for proper function of zones 200, 300, and 400.

A treated aqueous stream 103 for use in the process can be produced by routing an aqueous stream 102 to an aqueous treatment zone 1000 to produce a treated aqueous stream 103. The aqueous stream comprises water and is treated to remove multivalent cations from the water. Removal of multivalent metal cations from the aqueous stream 102 is one function of the aqueous treatment zone 1000. In embodiments, the concentration of multivalent cations is less than 100 ppm by weight, less than 60 ppm by weight, less than 25 ppm by weight, less than 10 ppm by weight, or less than 5 ppm by weight. The temperature of stream 103 can range from ground water temperature to 40° C.

The treatment of the aqueous stream 102 in the aqueous treatment zone 1000 can be accomplished in any way know in the art. In embodiments, aqueous treatment zone 1000 comprises distillation equipment wherein water vapor is generated and condensed to produce the treated aqueous stream 103. In embodiments, water is routed to a reverse osmosis membrane separation capable of separating monovalent and multivalent metal cations from water to produce the treated aqueous stream 103. In embodiments, water is routed to an ion exchange resin to generate the treated aqueous stream 103 with acceptably low concentration of metal cations. Also, water can be routed to a commercial water softening apparatus to generate the treated aqueous stream 103 with an acceptably low concentration of multivalent metal cations. It is understood that any combinations of these water treatment options may be employed to achieve the required treated water characteristics.

The treated aqueous stream 103 may be routed to any location in the process where it is needed. In embodiments, a portion of stream 103 is routed to a primary solid liquid separation zone 500 to serve as machine wash, filter media wash, and/or a wash for solids contained in the primary solid liquid separation zone 500.

In embodiments, at least a portion of the treated aqueous stream 103 is routed to heat exchanger zone 800 to produce a heated aqueous stream 801 and at least a portion of the treated aqueous stream 103 is routed to the mixing zone 300. Streams that can feed heat exchanger zone 800 include the treated aqueous stream 103, a portion of the primary recovered water stream 703, a portion of the first mother liquor stream 501, and a portion the second mother liquor stream 601. One function of heat exchanger zone 800 is to generate a heated aqueous stream 801 at a specific and controlled temperature. Equipment for controlling the temperature of 801 was described earlier and is not repeated here.

The SCMF solids stream 101 is routed to wash zone 200 to facilitate the washing of at least a portion of the impurities off the surface of the SCMF stream solids. The need to remove impurities was described earlier and is not repeated here.

The temperature of wash solvent stream 201 can range from 20° C. to 60° C., 30° C. to 60° C., 40° C. and 60° C., or 50° C. and 60° C.

The composition of wash solvent stream 201 comprises water. A small concentration surfactant and or organic solvent may also be present to help wash away certain impurities. For example, a surfactant is typically required to wash oils of SCMF solids. Suitable surfactants include but is not limited to anionic surfactants, non-ionic surfactants, and the like. Suitable organic solvents include but is not limited to alcohols, acetone, ketones, ethers, esters, and the like.

In embodiments, SCMF solids stream 101 is in the physical form of cut fiber. The concentration of SCMF in the wash zone is controlled, such that the mixture of wash solvent composition 201 and SCMF solids stream 101 is a pumpable slurry. It is also desirable that the concentration of the SCMF solids in the wash zone are controlled such that the mixture of wash solvent composition 201 and SCMF stream 101 generate a non-settling mixture in a well agitated tank. The concentration of SCMF in the wash zone can range from 0.1 wt % to 10 wt %, from 0.1 wt % to 8 wt %, from 0.1 wt % to 6 wt %, from 0.1 wt % to 4 wt %, from 0.1 wt % to 3 wt %, and from 0.1 wt % to 2 wt %, relative to the total combined weight of streams 101 and 201.

The functions of washing and dewatering of solids present in wash zone 200 were described earlier and are applicable here.

These two functions of washing and dewatering can be accomplished in the same unit operation or separate unit operations in both batch and continuous equipment. Examples of equipment suitable for batch washing and continuous washing were described previously and are applicable here.

Washed SCMF solids stream 203 and treated water stream 103 are routed to mix zone 300 where the substantially dewatered solids in stream 203 are re-slurred to form SCMF stream 301. Any equipment known in the art suitable for mixing a solid with water and maintaining the resulting suspension of cut multicomponent fibers in the continuous phase may be used in the fiber slurry zone 300. Equipment suitable for mix zone 300 include batch mix vessels or continuous mix vessels. Mix zone 300 can comprise batch or continuous mixing devices operated in continuous or batch mode. Suitable devices for use in the fiber slurry zone 300 include, but are not limited to, a hydro-pulper, a continuous stirred tank reactor, a tank with agitation operated in batch mode.

There is no limitation on residence time. Agitation in tanks must be enough to generate a substantially homogenous slurry that is pumpable. The wt % of cut multicomponent fibers in the SCMF slurry 301 can range from 10 wt % to 0.5% wt %, 8 wt % to 0.5 wt %, 5 wt % to 0.5 wt %, or 3 wt % to 0.5 wt %.

The temperature of the SCMF 301 can range from 5° C. to 45° C., from 10° C. to 35° C., or from 10° C. to 25° C. In embodiments, mix slurry zone 300 comprises a tank with sufficient agitation to generate a suspension of cut multicomponent fiber in a continuous aqueous phase.

The SCMF slurry 301 can then be routed to a fiber opening zone 400. One function of fiber opening zone 400 is to separate the water-dispersible polymer from the SCMF such that at least a portion of the water non-dispersible polymer separate from the SCMF and become suspended in the opened SCMF slurry 401. In embodiments, from 50 wt % to 100 wt % of water non-dispersible polymer contained in the SCMF slurry 301 becomes suspended in the opened SCMF slurry 401 as water non-dispersible polymer and is no longer a part of the SCMF. In embodiments, from 75 wt % to 100 wt %, from 90 wt % to 100 wt %, or from 95 wt % to 100 wt % of the water non-dispersible polymer contained in the SCMF stream 301 becomes suspended in the opened SCMF slurry 401 as water non-dispersible polymer are no longer a part of a cut multicomponent fiber.

Residence time, temperature, and shear forces in the fiber opening zone 400 also influence the extent of separation of the water-dispersible sulfopolyester from the SCMF. The conditions influencing the opening process in fiber opening zone 400 comprise residence time, slurry temperature, and shear forces where the ranges of water temperature, residence time in the fiber opening zone 400, and amount of applied shear force are dictated by the need to separate the water-dispersible sulfopolyester from the starting multicomponent fiber to a sufficient degree to result in water non-dispersible polymer microfibers becoming separated and suspended in the continuous aqueous phase of the opened microfiber slurry 401.

The temperature of the SCMF opening zone 400 can range from 61° C. to 140° C., from 65° C. to 135° C., from 70° C. to 130° C., from 75° C. to 125° C., from 80° C. to 120° C., from 80° C. to 115° C., from 80° C. to 110° C., from 80° C. to 105° C., from 80° C. to 100° C., or from 80° C. to 90° C. The residence time in the fiber opening zone 400 can range from 10 secs to 10 minutes, 20 secs to 8 minutes, 20 secs to 5 minutes, 20 secs to 4 minutes, 20 secs to 3 minutes, 20 secs to 2 minutes, or 20 secs to 1 minute.

Sufficient mixing is maintained in SCMF opening zone 400 to maintain a suspension of cut water non-dispersible polymer such that the settling is minimal. In embodiments, the mass per unit time of cut water non-dispersible fibers settling in the SCMF opening zone 400 is less than 5% of the mass per unit time of cut water non-dispersible polymer microfibers entering the zone 400, less than 3% of the mass per unit time of cut water non-dispersible polymer fibers entering zone 400, or less than 1% of the mass per unit time of cut water non-dispersible polymer fibers entering the fiber opening zone 400.

Opening of the SCMF in the opening zone 400 may be accomplished in any equipment capable of allowing for acceptable ranges of residence time, temperature, and mixing. Examples of suitable equipment include, but are not limited to, an agitated batch tank, a continuous stirred tank reactor, and a pipe with sufficient flow to minimize solids from settling out of the slurry. One example of a unit operation to accomplish fiber opening in fiber opening zone 400 is a plug flow reactor where the heated multicomponent fiber slurry 301 is routed to zone 400 plug flow device, typically a circular pipe or conduit. The residence time of material in a plug flow device is calculated by dividing the filled volume within the device by the volumetric flow rate in the device. Velocity of the mass in the device is defined by the cross- sectional area of the flow channel divided by the volumetric flow of the liquid through the device.

In embodiments, the fiber opening zone 400 can comprise a pipe or conduit wherein the velocity of mass flowing in the pipe can range from 0.1 ft/second to 20 feet/second, from 0.2 ft/sec to 10 ft/sec, or from 0.5 ft/sec to 5 ft/sec. Reynolds number (Re) is useful for describing the turbulence or motion of fluid eddy currents that are irregular with respect both to direction and time. Since it was described earlier, it will not be repeated here.

SCMF opening zone 400 can be achieved in a pipe or conduit containing a mixing device inserted within the pipe or conduit. The device can comprise an in-line mixing device. The in-line mixing device can be a static mixer with no moving parts. In embodiments, the in-line mixing device comprises moving parts. Without being limiting, such an element is a mechanical device for the purpose of imparting more mixing energy to the heated multicomponent fiber slurry 301 than achieved by the flow through the pipe. The device can be inserted at the beginning of the pipe section used as the fiber opening zone, at the end of the pipe section, or at any location within the pipe flow path.

The opened SCMF slurry stream 401 comprising cut water non-dispersible polymer fiber, water, and water-dispersible sulfopolyester can be routed to a primary solid liquid separation zone 500 to generate a microfiber product stream 503 comprising microfiber and a first mother liquor stream 501. In embodiments, the first mother liquor stream 501 comprises an aqueous dispersion comprising water-dispersible sulfopolyester.

The wt % of solids in the opened microfiber slurry 401 can range from 0.1 wt % to 20 wt %, from 0.3 wt % to 10 wt %, from 0.3 wt % to 5 wt %, or from 0.3 wt % to 2.5 wt %.

The wt % of solids in the microfiber product stream 503 can range from 10 wt % to 65 wt %, from 15 wt % to 50 wt %, from 25 wt % to 45 wt %, or from 30 wt % to 40 wt %.

Separation of the microfiber product stream 503 from the opened microfiber slurry 401 can be accomplished by any method known in the art. In embodiments, wash stream 103 comprising water is routed to the primary solid liquid separation zone 500. Wash stream 103 can be used to wash the microfiber product stream in the primary solid liquid separation zone 500 and/or the filter cloth media in the primary solid liquid separation zone 500 to generate wash liquor stream 502. A portion up to 100 wt % of wash liquor stream 502 can be combined with the opened microfiber slurry 401 prior to entering the primary solid liquid separation zone 500. A portion up to 100 wt % of wash liquor stream 502 can be routed to a second solid liquid separation zone 600. Wash liquor stream 502 can contain microfiber. In embodiments, the grams of microfiber mass breaking though the filter media with openings up to 2000 microns in the primary solid liquid separation zone 500 ranges from 1 to 2 grams/cm² of filter area. In embodiments, the filter openings in the filter media in the primary solid liquid separation zone 500 can range from 43 microns to 3000 microns, from 100 microns to 2000 microns, or from 500 microns to 2000 microns.

Separation of the microfiber product stream from the opened microfiber slurry in primary solid liquid separation zone 500 can be accomplished by a single or multiple solid liquid separation devices. Separation in the primary solid liquid separation zone 500 may be accomplished by a solid liquid separation device or devices operated in batch and or continuous fashion. Suitable solid liquid separation devices in the primary solid liquid separation zone 500 can include, but is not limited to, at least one of the following:

perforated basket centrifuges, continuous vacuum belt filters, batch vacuum nutsche filters, batch perforated settling tanks, twin wire dewatering devices, continuous horizontal belt filters with a compressive zone, non-vibrating inclined screen devices with wedge wire filter media, continuous vacuum drum filters, dewatering conveyor belts, and the like.

In embodiments, the primary SLS zone 500 comprises a twin wire dewatering device wherein the opened SCMF slurry 401 is routed to a tapering gap between a pair of traveling filter cloths traveling in the same direction. In the first zone of the twin wire dewatering device, water drains from the opened microfiber slurry 401 due to gravity and the very narrowing gap between the two moving filter cloths. In a downstream zone of the twin wire dewatering device, the two filter cloths and the microfiber mass between the two filter cloths are compressed one or more times to mechanically reduce moisture in the microfiber mass. In embodiments, mechanical dewatering is accomplished by passing the two filter cloths and contained microfiber mass through at least one set of rollers that exert a compressive force on the two filter cloths and microfiber mass between. In embodiments, mechanical dewatering is accomplished by passing the two filter cloths and microfiber mass between at least one set of pressure rollers.

In embodiments, the force exerted by mechanical dewatering for each set of pressure rollers can range from 25 to 300 lbs/linear inch of filter media width, from 50 to 200 lbs/linear inch of filter media width, or from 70 to 125 lbs/linear inch of filter media width. The microfiber product stream 503 is discharged from the twin wire water dewatering device as the two filter cloths separate and diverge at the solids discharge zone of the device. The thickness of the discharged microfiber mass can range from 0.2 inches to 1.5 inches, from 0.3 inches to 1.25 inches, or from 0.4 inches to 1 inch. In embodiments, a wash stream comprising water is continuously applied to the filter media. In embodiments, a wash stream comprising water is periodically applied to the filter media.

In embodiments, the primary SLS zone 500 comprises a belt filter device comprising a gravity drainage zone and a pressure dewatering zone.

Opened SCMF slurry 401 is routed to a tapering gap between a pair of moving filter cloths traveling in the same direction which first pass through a gravity drainage zone and then pass through a pressure dewatering zone or press zone comprising a convoluted arrangement of rollers. As the belts are fed through the rollers, water is squeezed out of the solids. When the belts pass through the final pair of rollers in the process, the filter cloths are separated and the solids exit the belt filter device.

In embodiments, at least a portion of the water contained in the first mother liquor stream 501 comprising aqueous dispersion of sulfopolyester can be recovered and recycled. The first mother liquor stream 501 can be recycled to the primary SLS zone 500. Depending on the efficiency of the primary liquid separation zone in the removal of the water non-dispersible microfiber, the first mother liquid stream 501 can be recycled to the SCMF slurry zone 300, the fiber opening zone 400, or the heat exchanger zone 800 prior to being routed to zone 400. The first mother liquor stream 501 can contain a small amount of solids comprising water non-dispersible polymer microfiber due to breakthrough and wash, for example machine wash. In embodiments, the grams of water non-dispersible polymer microfiber mass breaking though filter media in the primary solid liquid separation zone with openings up to 2000 microns ranges from 1 to 2 grams/cm² of filter area. It is desirable to minimize the water non-dispersible polymer microfiber solids in the first mother liquor stream 501 prior to routing stream 501 to the primary concentration zone 700 and heat exchange zone 800 where water non-dispersible polymer microfiber solids can collect and accumulate in the zones having a negative impact on their function.

A secondary SLS zone 600 can serve to remove at least a portion of water non-dispersible polymer microfiber solids present in the first mother liquor stream 501 to generate a secondary wet cake stream 602 comprising water non-dispersible microfiber and a second mother liquor stream 601 comprising an aqueous dispersion of water-dispersible sulfopolyester.

In embodiments, the second mother liquor stream 601 can be routed to a primary concentration zone 700 and or heat exchanger zone 800 wherein the wt % of the second mother liquor stream 601 routed to the primary concentration zone 700 can range from 0% to 100% with the balance of the stream being routed to heat exchanger zone 800. The second mother liquor stream 601 can be recycled to the fiber slurry zone 200, the fiber opening zone 400, or the heat exchanger zone 800 prior to being routed to Zones 200 and/or 400. The amount of the water-dispersible sulfopolyester in the second mother liquor stream routed to the fiber opening zone 400 can range from 0.01 wt % to 7 wt %, based on the wt % of the second mother liquor stream, or from 0.1 wt % to 7 wt %, from 0.2 wt % to 5 wt %, or from 0.3 wt % to 3 wt %.

Any portion of the second mother liquor 601 routed to primary concentration zone is subjected to a separation process to generate a primary recovered water stream 703 and a primary SFP concentrate stream 702 enriched in water-dispersible sulfopolyester wherein the wt % of water-dispersible sulfopolyester in the primary SFP concentrate stream 702 can range from between 1 wt % to 40 wt %, between 1 wt % to 30 wt %, between 1 wt % to 25 wt %, between 1 wt % to 20 wt %, between 1 wt % to 15 wt %, between 5 wt % to 30 wt %, between 10 wt % to 30 wt %, between 15 wt % to 30 wt %, between 20 wt % to 30 wt %, or between 25 wt % to 30 wt %, relative to the total weight of the concentrated sulfopolyester dispersion. Primary SFP concentrate stream 702 constitutes a recovery of 50% to 99.9%, 75% to 99.9%, 65%, 75% to 99.9%, 75% to 99%, 80% to 98%, 85% to 97%, 90% to 96%, or 91% to 95% of the sulfopolyester in the composite material.

The primary recovered water stream 703 can be recycled to the fiber opening zone 400, or the heat exchanger zone 800 prior to being routed to zone 400. The amount of the water-dispersible sulfopolyester in the second mother liquor stream routed to the fiber opening zone 400 can range from 0.01 wt % to 7 wt %, based on the wt % of the second mother liquor stream, or from 0.1 wt % to 7 wt %, from 0.2 wt % to 5 wt %, or from 0.3 wt % to 3 wt %.

As described earlier, water can be removed from the second mother liquor stream 601 by any method know in the art in the primary concentration zone 700 to produce the primary SFP concentrate stream 702. The removal of water by the evaporative process or by membrane technology described earlier is applicable here. Moreover, membrane filtration for concentration of sulfopolyester accomplished in a batch or continuous fashion discussed earlier is also applicable here.

In embodiments, the primary polymer concentrate stream 702 can be routed to a secondary concentration zone 900 to generate a melted polymer stream 903 comprising water-dispersible sulfopolyester wherein the wt % of polymer ranges from 95% to 100% and a vapor stream 902 comprising water. In embodiments, the 903 comprises water-dispersible sulfopolyester. Equipment suitable for the secondary concentration zone 900 includes any equipment known in the art capable of being fed an aqueous dispersion of water-dispersible polymer and generating a 95% to 100% water-dispersible polymer stream 903. This embodiment comprises feeding an aqueous dispersion of water-dispersible sulfopolyester polymer to a secondary concentration zone 902. The temperature of feed stream is typically below 100° C.

In embodiments, the secondary concentration zone 900 comprises at least one device characterized by a jacketed tubular shell containing a rotating convey screw wherein the convey screw is heated with a heat transfer fluid or steam and comprises both convey and high shear mixing elements. The jacket or shell is vented to allow for vapor to escape. The shell jacket may be zoned to allow for different temperature set points along the length of the device. During continuous operation, the primary polymer concentrate stream 702 comprises an aqueous dispersion of water-dispersible sulfopolyester and is continuously fed to the secondary concentration zone 900. Within the device, during steady state, mass exists in at least three distinct and different forms, as described earlier and is applicable here.

In embodiments, vapor generated in the secondary concentration zone 900 may be condensed and routed to heat exchanger zone 800, discarded, and/or routed to wash stream 103. In embodiments, condensed vapor stream 902 comprising water vapor can be routed to heat exchanger zone 800 to provide at least part of the energy required for generating the required temperature for stream 801. The melted polymer stream 903 comprising water-dispersible polymer comprising sulfopolyester in the melt phase can be cooled to a solid and chopped into pellets by any method known in the art.

Impurities can enter the process and concentrated in water recovered and recycled. One or more purge streams (603 and 701) can be utilized to control the concentration of impurities in the second mother liquor 601 and primary recovered water stream 701 to acceptable levels. In embodiments, a portion of the second mother liquor stream 601 can be isolated and purged from the process. In embodiments, a portion of the primary recovered water stream 701 can be isolated and purged from the process.

The recovered sulfopolyester can be reused in a manufacturing process. Exemplary uses for the recovered sulfopolyester include the formation of new articles or products, such as sizing agent, dust suppressant, binder for nonwoven fabrics, ink additives, non-woven fabric, multicomponent fibers, films, clothing articles, personal care products such as wipes, feminine hygiene products, diapers, adult incontinence briefs, medical disposables, protective fabrics and layers, geotextiles, industrial wipes, and filter media. adhesives, cosmetics and personal care, foil lining coating, graphic arts, concrete sealant, wood coatings, automotive plastics, film former/modifier, paper coating, packaging material, carpet stain resistance, ore frothing for floating, and general coatings.

### Sizing Agent

In embodiments, the recovered sulfopolyester described herein can be used as a sizing agent in a sizing composition. The recovered sulfopolyester can be in the form of a recovered sulfopolyester dispersion. A recovered sulfopolyester dispersion can be used as a sizing agent to size one or more of fibers, filaments, fibrous articles (e.g., textile yarn, hemp rope, tire cord, yarn on a warped beam, etc.), paper materials, fabrics (e.g., draperies, home furnishings, etc.), non-woven materials (e.g., wet laid nonwovens), etc. As used herein, “sizing” refers to the process of applying a protective coating or film.

A sizing composition including the recovered sulfopolyester dispersion can be used to treat warp yarn. When textile materials are to be used in the form of multifilament yarns for the fabrication of textile materials, it is desirable before the weaving process to treat the warp yarn with a sizing composition which adheres to and binds the several filaments together. This treatment strengthens the several filaments and renders them more resistant to abrasion during the subsequent weaving operations. It is especially important that the sizing composition impart abrasion resistance to the yarns during weaving because abrasion tends to sever the yarn and to produce end breaks which, of course, lowers the quality of the final woven product.

In embodiments, for greater effectiveness, it is necessary that a textile size be substantially scoured or removed from the woven fabric so that it will not interfere with subsequent finishing and dyeing operations. In practical terms, this means that the sizing composition, to be removable, must be water-dissipatable (that is, either water-soluble or water-dispersible). The recovered sulfopolyester is water-dispersible.

The sizing compositions described herein are particularly useful for sizing polyester yarn, which is among the most difficult of all textile yarns to size. The sizing compositions of described herein make it possible to weave low or zero twist polyester fibers with substantially no defects. The Tg is important to the performance of a sulfopolyester as a size. In embodiments, the

Tg of the recovered sulfopolyester is in the range in from 25° C. to 50° C. or from 30° C. to 40° C. Addition of a plasticizing component may be used to lower the Tg of the sulfopolyester, and polyethylene glycol (PEG) is a preferred option for this purpose although other additives may be used.

In embodiments, the sizing composition is not removed, such as with sizing tire cord (such as rayon, nylon, or polyester tire cord) and hemp rope.

The recovered sulfopolyester dispersion can alter one or more of an abrasiveness, a creasibility, a finish, a printability, a smoothness, or a surface bond strength of a textile. Additionally, the recovered sulfopolyester dispersion can decrease surface porosity or fuzzing of a textile. Moreover, the recovered sulfopolyester dispersion can alter the absorption of a textile by reducing the absorption of an ink when the ink is applied to the textile. Further, sizing using the recovered sulfopolyester dispersion can create a smoother and/or water-repellant surface to paper and/or improve the surface strength and printability of paper.

Sizing compositions described herein can also include the recovered sulfopolyester dispersion can also include one or more of polyethylene glycol, plasticizers, dye(s), pigment(s), talc, titanium dioxide, or stabilizer(s).

In embodiments, the recovered sulfopolyester dispersion is present in the sizing composition at a wt % from 0.1% to 40%, 0.5% to 35%, 1% to 30%, 2% to 25%, 3% to 20%, 4% to 15%, or 5% to 10%, relative to the total weight of the sizing composition.

The disclosure also describes a process for using a recovered sulfopolyester dispersion in the manufacture of a sizing composition. The process comprises obtaining a recovered sulfopolyester dispersion and combining the recovered sulfopolyester dispersion with other components such as at least water. Additional components as described above, for example, water, polyethylene glycol, plasticizers, dye(s), pigment(s), talc, titanium dioxide, stabilizer(s), thickening agent(s), etc., can be combined with the recovered sulfopolyester dispersion and water.

Moreover, the disclosure describes a process for using the recovered sulfopolyester dispersion as a sizing agent in the manufacture of textile materials and other materials and articles. A sizing composition containing the recovered sulfopolyester dispersion can be applied to the material and/or article. In embodiments, a recovered sulfopolyester dispersion can be used as a sizing agent in the manufacture of a yarn on a warped beam, paper material, fabric, or non-woven material.

### Dust Suppressant

Dust, especially those from industrial sources, is a major cause of air pollution. Everyone is aware that the dust which is created in coal mining operations is considered to be a major cause of pneumoconiosis, more commonly known as black lung disease. Since dust is confined within a small air space in coal mining operations, dust explosions are a serious hazard. Moreover, a large amount of coal dust is created through transportation, handling, and storage. Open operations, leaks and spills, storage and disposal, and poor housekeeping are also sources of common industrial sources of dust.

Dust suppression refers to prevention and/or reduction of the suspension of finely particulate solid matter in a gas, usually air. The finely particulate solid matter can either already be in existence or being produced by various mechanical operations such as grinding, milling, cutting, pounding, explosion, and the like. There is a need to develop a method for suppressing dust.

In examples, the recovered sulfopolyester described herein can be used as a dust suppressant in a dust suppressant composition. The recovered sulfopolyester can be in the form of a recovered sulfopolyester dispersion. The recovered sulfopolyester dispersion described herein provides a method by which dust can be suppressed. The recovered sulfopolyester dispersion can prevent or reduce the suspension of dust in the air.

In embodiments, a dust suppressant composition containing a recovered sulfopolyester dispersion can be applied to roads, airfields, helipads, etc. to control fugitive dust. In embodiments, the recovered polyester permeates and aggregates fine dust particles to reduce airborne dust and runoff by strengthening the surface of the soil. The dust suppressant composition can be used for erosion control, for stabilization of roads, etc. Use of a dust suppressant composition that includes a recovered polyester dispersion reduces or eliminates the need to apply water to the surface to which it is applied for ongoing dust control. Reducing dust can reduce respiratory illness, equipment malfunction, and lack of visibility.

In embodiments, a dust suppressant composition containing a recovered sulfopolyester dispersion can be applied to other materials including but not limited to coal, rock, ores, taconite, sulfur, copper, limestone, gypsum, fly ash, cement, bauxite, ash, sinter, coke, a mineral concentrate, or a fertilizer.

In embodiments, dust suppressant compositions that include the recovered sulfopolyester dispersion can include additional water (beyond the water that is part of the dispersion) and one or more other components including but not limited to surfactant(s), an acrylic polymer (e.g., vinyl acrylic polymer), a polyvinyl acetate polymer, potassium hydroxide, sodium hydroxide, potassium methylsiliconate, sodium methylsiliconate, an ester, glycerin, or a combination thereof. Examples of surfactants include sodium dodecylbenzene sulfonate, ethoxylated alcohol and sodium lauryl sulfate.

In embodiments, the amount of recovered polyester present in the dust suppression composition is from amount of recovered sulfopolyester is from 0.1 wt % to 40 wt %, 0.5 wt % to 40 wt %, 1 wt % to 40 wt %, 2 wt to 40 wt %, 5 wt % to 40 wt %, 10 wt % to 40 wt %, 15 wt % to 40 wt %, or 20 wt % to 40 wt %, relative to the total weight of the dust suppressant.

In embodiments, the disclosure describes a process for using a recovered sulfopolyester dispersion in the manufacture of a dust suppressant composition. The process comprises obtaining a recovered sulfopolyester dispersion and combining the recovered sulfopolyester dispersion with one or more additional components as described above, for example, surfactant(s), an acrylic polymer (vinyl acrylic polymer), a polyvinyl acetate polymer, potassium hydroxide, sodium hydroxide, potassium methylsiliconate, sodium methylsiliconate, an ester, glycerin, etc.

In embodiments, the present disclosure describes a method for using a dust suppressant composition that contains the recovered sulfopolyester to suppress dust on roads. A dust suppressant composition as described above can be sprayed onto the road surface and allowed to dry. This causes the soil particles to form a “crust” that reduces the airborne dust.

In embodiments, this disclosure describes a method for using a dust suppressant composition that contains the recovered sulfopolyester to suppress dust from coal, rock, ores, taconite, sulfur, copper, limestone, gypsum, fly ash, cement, bauxite, ash, sinter, coke, a mineral concentrate, or a fertilizer.

### Binder

Nonwoven fabrics are typically manufactured by putting fibers together in the form of a sheet or web and then binding them either mechanically (with an adhesive) or thermally (by applying a binding composition (in the form of powder, paste, or polymer melt) and melting the binding composition onto the web by increasing temperature). The web of fibers can be in the form of wetlaid process or drylaid process. In the wetlaid process, the fibers making up the non-woven fabric are dispersed in water and formed into a sheet or web. After most of the water is removed, the fibers are bonded by the application of some type of binder (generally latex). In the drylaid process, dry fibers are subjected to a carding operation which forms the fibers into a web, then a binder is applied to the web to hold the fibers together. The thermal bonding process is a process in which binder fibers are used to form thermally bonded fibrous structures.

The binding composition comprising a binding agent is applied to the web of fibers and holds the fibers together mechanically to form a cohesive nonwoven fabric. As used herein, “nonwoven fabric” is a sheet or web structure made from fibers or filaments bonded together by chemical, mechanical, thermal, or solvent treatment, made without weaving or knitting. Nonwoven fabrics can provide specific functions such as absorbency, liquid repellence, resilience, stretch, softness, strength, flame retardancy, washability, cushioning, thermal insulation, acoustic insulation, filtration, use as a bacterial barrier and sterility.

Melt-blown Nonwoven fabrics can be produced by extruding melted polymer fibers through a spin net or die to form long thin fibers which are stretched and cooled by passing hot air over the fibers as they fall from the die. The resultant web is collected into rolls and subsequently converted to finished products.

In embodiments, the recovered sulfopolyester described herein can be used as a binding agent in the manufacture of nonwoven materials. The recovered sulfopolyester can be in the form of a recovered sulfopolyester dispersion, wherein the recovered sulfopolyester dispersion comprises at least recovered sulfopolyester and water. The recovered sulfopolyester dispersion can be combined with one or more binding agents in a binding composition. The amount of recovered sulfopolyester ranges from 0.1 wt % to 40 wt %, 0.5 wt % to 40 wt %, 1 wt % to 40 wt %, 2 wt to 40 wt %, 5 wt % to 40 wt %, 10 wt % to 40 wt %, 15 wt % to 40 wt %, or 20 wt % to 40 wt %, relative to the total weight of the binder composition.

In embodiments, the recovered sulfopolyester dispersion binder composition can alter at least one of the dry tensile strength, wet tensile strength, tear force, or burst strength of a nonwoven material.

In embodiments, a binding composition can comprise a recovered sulfopolyester dispersion and one or more additives. The one or more additives can include but are not limited to thermoplastic polycondensate fibers.

In embodiments, the disclosure describes a process for using a recovered sulfopolyester dispersion in the manufacture of a binding composition. The process comprises obtaining a recovered sulfopolyester dispersion and combining the recovered sulfopolyester dispersion with additives including but not limited to thermoplastic polycondensate fibers.

In embodiments, this disclosure describes a process for using a recovered sulfopolyester dispersion as a binding agent in the manufacture of a nonwoven composition. A binding composition containing the recovered sulfopolyester dispersion can be applied to the nonwoven material to form the nonwoven composition. In embodiments, the nonwoven material comprises at least one of a spun-bounded nonwoven material, a heat sealing nonwoven material, a spunlace nonwoven material, a needle punched nonwoven material, a melt-blown nonwoven material, a stitch-bonded nonwoven material, an airlaid pulp nonwoven material, a wet nonwoven material, filter media, battery separators, personal hygiene articles, sanitary napkins, tampons, diapers, disposable wipes, flexible packaging, geotextiles, building and construction materials, surgical and medical material, security papers, cardboard, recycled cardboard, synthetic leather and suede, automotive headliners, personal protective garments, acoustical media, concrete reinforcement, flexible perform for compression molded composites, electrical materials, catalytic support membranes, thermal insulation, labels, food packaging material, or printing or publishing papers.

In embodiments, a nonwoven article comprises a plurality of thermoplastic polycondensate fibers and a binding composition that includes a recovered sulfopolyester dispersion. The thermoplastic polycondensate fibers can comprise a polyester and/or a polyamide and make up 1 wt % to 10 wt %, 5 wt % to 20 wt %, 10 wt % to 30 wt %, 20 wt % to 40 wt %, 30 wt % to 50 wt %, or 60 wt %, relative to the total weight of the nonwoven composition. of the total fiber content of the nonwoven article, whereas the recovered sulfopolyester makes up at least 0.1 wt % and not more than 40 wt % of the nonwoven article. The binding composition can make up 0.1 wt % to 10 wt %, 0.1 wt % to 7 wt %, 0.1 wt % to 5 wt %, or 0.1 wt % to 3 wt %, relative to the total weight of the nonwoven composition. The nonwoven article further comprises a plurality of synthetic microfibers having a length of less than 25 millimeters and a minimum transverse dimension of less than 5 microns, wherein the synthetic microfibers make up at least 1 wt % of the nonwoven article.

In embodiments, the binding composition can comprise the recovered sulfopolyester dispersion described herein and another sulfopolyester.

In embodiments, a bound nonwoven article can be produced using recovered sulfopolyester dispersion. The first step of the process involves a) producing multicomponent fibers comprising at least one water-dispersible recovered sulfopolyester and one or more water non-dispersible polymers immiscible with the recovered sulfopolyester. The multicomponent fibers can have an as-spun denier of less than 15 dpf. The next step b) involves cutting the multicomponent fibers into cut multicomponent fibers having a length of less than 25 millimeters. Step c) involves contacting the cut multicomponent fibers with water to remove the recovered sulfopolyester thereby forming a wet lap comprising cut water non-dispersible fibers, which are formed of a thermoplastic polycondensate. Step d) involves transferring the wet lap to a wetlaid nonwoven zone to produce an unbound nonwoven article. The final step e) involves applying a binder dispersion comprising at least one recovered sulfopolyester to the nonwoven article.

In embodiments, a nonwoven article can be produced using recovered sulfopolyester dispersion by (1) spinning the sulfopolyester with a water-non-dispersible synthetic polymer into multicomponent fibers, (2) cutting the multicomponent fibers to a length of less than 25, 12, 10, or 2 millimeters, but greater than 0.1 , 0.25, or 0.5 millimeters to produce cut multicomponent fibers; (3) contacting the cut multicomponent fibers with water to remove the sulfopolyester thereby forming a wet lap of binder microfibers comprising the water non-dispersible synthetic polymer; (4) subjecting a plurality of fibers and the binder microfibers to a wetlaid nonwoven process to produce a wetlaid nonwoven web; wherein water non-dispersible microfibers have a fineness of less than 0.5 d/f; and wherein the binder microfibers have a melting temperature that is less than the melting temperature of the fibers; and (5) removing water from the wetlaid nonwoven web; and (6) thermally bonding the wetlaid nonwoven web after step (5), wherein the thermal bonding is conducted at a temperature such that the surfaces of the binder microfibers at least partially melt without causing the fibers to melt thereby bonding the binder microfibers to the fibers to produce the paper or nonwoven article. In one embodiment of the invention, at least 5 wt %, 10 wt %, 15 wt %, 20 wt %, 30 wt %, 40 wt %, or 50 wt % and/or not more than 90 wt %, 75 wt %, or 60 wt % of the nonwoven web comprises the binder microfibers.

### Ink Additives

In embodiments, the recovered sulfopolyester described herein can be used in an ink composition. The recovered sulfopolyester can be in the form of a recovered sulfopolyester dispersion and can aid in the dispersion of pigments or colorants in water. Additionally, a recovered sulfopolyester dispersion can decrease the drying time of the ink. Moreover, the recovered sulfopolyester dispersion can reduce or eliminate the need for surfactants in the ink compositions.

The term “ink” or “ink composition” is used herein in its broad sense as including the use thereof for coatings in all forms such as letters, patterns, and coatings without design, whether or not such coatings contain colorants such as pigments, and include finished inks, overprints, and primers. The present disclosure is not limited to any type of colorant and can accommodate any pigment or disperse dye which can be dispersed, milled, mixed, blended or dissolved in any manner in either the polyester, water, or aqueous polymer system.

In embodiments, a recovered sulfopolyester dispersion imparts improved water resistance and block resistance properties to printing inks for certain substrates (e.g., certain metals such as aluminum foil and plastics such as poly(ethylene terephthalate)). Other substrates can include metal foil, newsprint, bleached and unbleached Kraft paper, clay coated paper, glass, calendared paper, stainless paper, paper board, and films or other substrates of polyester, polycarbonate, cellulose ester, regenerated cellulose, poly(vinylidene chloride), polyamide, polypropylene, polyethylene, polystyrene, etc. The ink compositions of described herein can be for any of the typical ink applications such as flexographic, gravure, letterpress, ink-jet, or screen-process printing applications. The ink compositions described herein generally have a pH of 8.2 or lower; in embodiments, the pH of the ink composition described herein is 5 to 8. If the pH is higher than 8.2, there is a danger of the polymer(s) hydrolyzing which can result in gelling of the system under certain circumstances.

In embodiments, the recovered polyester dispersion described herein can be combined with colorant and water to form an ink composition. The amount of recovered sulfopolyester present in the ink composition is in a range from 1 wt % to 80 wt %, 2 wt % to 75 wt %, 3 wt % to 75 wt %, 5 wt % to 70 wt %, 7 wt % to 65 wt %, 10 wt % to 60 wt %, 15 wt % to 55 wt %, 20 wt % to 50 wt %, relative to the total weight of the ink composition.

The amount of water present in the ink composition ranges from 15 wt % to 95 wt %, 25 wt % to 90 wt %, or 35% to 90 wt %, relative to the total of the ink composition.

In embodiments, the ink composition further includes one or more colorant. The amount of colorant present in the ink composition is from 0.1 wt % to 45 wt %, 0.5 wt % to 35 wt %, or 1.0% to 30%, or 2 wt % to 15 wt %. In embodiments, in which the ink composition is a finished ink, generally at least 0.5 wt % of colorant is present. If the ink composition contains an organic pigment, typically such an organic pigment is present in an amount of 17.5 wt % or less of the total composition. If the ink composition contains an inorganic pigment, typically such inorganic pigment is present in an amount of 50 wt % or less of the total composition.

In embodiments, ink compositions that include recovered sulfopolyester can include additional additives comprising one or more of surfactant(s) (e.g., sodium lauryl sulfate); wetting agent(s); antifoaming agent(s), or dispersing agent(s). Additionally or alternatively, the ink compositions can include one or more of organic compounds; salt(s); resin(s); water-soluble organic solvent(s); water-miscible organic solvent(s); acrylic polymer(s); vinyl polymer(s); emulsified, dispersed, powdered, or micronized wax(es); alcohols containing 1 to 10 carbon atoms such as ethanol, methanol, n-propyl alcohol, or isopropyl alcohol; glycols such as ethylene glycol or propylene glycol; alcohol ethers such as propylene glycol monobutyl ether, ethylene glycol monobutyl ether, or propylene glycol monomethyl ether; biocides; pH stabilizers; thickeners; and the like.

The ink compositions can optionally contain up to 15 wt % of the total composition or up to 3 wt %, of the one or more additional additives. In embodiments, wax is present in the ink composition from 0 wt % to 3.0 wt %; surfactant is present in the ink composition from 0 wt % to 3.0 wt %; defoamer is present in the ink composition from 0 wt % to 2.0 wt %; and alcohol is present in the ink composition from 0 wt % to 10.0 wt %. A defoamer or antifoam can be present in an amount from 0.05 wt % to 0.25 wt % or from 0.1 wt % to 0.25 wt %. Biocides are typically present in an amount of from 0 wt % to 1 wt %. Waxes are especially useful in certain ink compositions, especially overprints, and such inks typically contain at least 0.01 wt % of one or more of the waxes.

In embodiments, the inherent viscosities (I.V.) of the recovered sulfopolyester are a least 0.1 as determined according to ASTM D2857-70 procedures, and can be from 0.2 to 1.0, from 0.2 to 0.6.

In embodiments, the disclosure describes a process for using recovered sulfopolyester in the manufacture of an ink composition. The process comprises obtaining the recovered sulfopolyester dispersion and combining the recovered sulfopolyester dispersion with other components, such as at least water. Additional additives as described above can be combined with the recovered sulfopolyester dispersion and water. In embodiments, the recovered sulfopolyester can be in the form of a resin or can be in solution when mixed with the other components.

In embodiments, to form the ink composition, a colorant is combined with recovered sulfopolyester dispersion and water. As an example, the colorant can be flushed into the recovered sulfopolyester dispersion. The colored recovered sulfopolyester dispersion can be dispersed in water with a shearing device.

The definition provided for a group or term herein applies to that group or term throughout the present specification individually or as part of another group, unless otherwise indicated. Additionally, it will be understood that any list of such examples or alternatives is merely illustrative, not limiting, unless implicitly or explicitly understood or stated otherwise.

The terms “a,” “an,” “the” and similar referents used in the context of describing the disclosed subject matter (especially in the context of the following claims) are to be construed to cover both the singular and the plural, unless otherwise indicated herein or clearly contradicted by context.

Each embodiment disclosed herein can comprise, consist essentially of or consist of its particular stated element, step, ingredient or component. Thus, the terms “include” or “including” should be interpreted to recite: “comprise, consist of, or consist essentially of.” The transition term “comprise” or “comprises” means includes, but is not limited to, and allows for the inclusion of unspecified elements, steps, ingredients, or components, even in major amounts. The transitional phrase “consisting of” excludes any element, step, ingredient or component not specified. The transition phrase “consisting essentially of” limits the scope of the embodiment to the specified elements, steps, ingredients or components and to those that do not materially affect the embodiment.

In addition, unless otherwise indicated, numbers expressing quantities of ingredients, constituents, reaction conditions and so forth used in the specification and claims are to be understood as being modified by the term “about.” Accordingly, unless indicated to the contrary, the numerical parameters set forth in the specification and attached claims are approximations that may vary depending upon the desired properties sought to be obtained by the subject matter presented herein. At the very least, and not as an attempt to limit the application of the doctrine of equivalents to the scope of the claims, each numerical parameter should at least be construed in light of the number of reported significant digits and by applying ordinary rounding techniques. When further clarity is required, the term “about” has the meaning reasonably ascribed to it by a person skilled in the art when used in conjunction with a stated numerical value or range, i.e. denoting somewhat more or somewhat less than the stated value or range, to within a range of ±20% of the stated value; ±15% of the stated value; ±10% of the stated value; ±5% of the stated value; ±4% of the stated value; ±3% of the stated value; ±2% of the stated value; ±1% of the stated value; or ±any percentage between 1% and 20% of the stated value.

Recitation of ranges of values herein is merely intended to serve as a shorthand method of referring individually to each separate value falling within the range. Unless otherwise indicated herein, each individual value is incorporated into the specification as if it were individually recited herein. It should be understood that the description in range format is merely for convenience and brevity and should not be construed as an inflexible limitation on the scope of the disclosure. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, and 6. This applies regardless of the breadth of the range.

All methods described herein can be performed in any suitable order unless otherwise indicated herein or otherwise clearly contradicted by context.

The use of any and all examples, or exemplary language (e.g., “such as”) provided herein is intended merely to better explain the disclosed subject matter and does not pose a limitation on the scope of the disclosed subject matter otherwise claimed. No language in the specification should be construed as indicating any non-claimed element essential to the practice of the disclosed subject matter.

Groupings of alternative elements or embodiments of the disclosed subject matter disclosed herein are not to be construed as limitations. Each group member may be referred to and claimed individually or in any combination with other members of the group or other elements found herein.

Certain embodiments of this disclosed subject matter are described herein, including the best mode known to the inventors for carrying out the disclosed subject matter. Of course, variations on these described embodiments will become apparent to those of ordinary skill in the art upon reading the foregoing description. The inventor expects skilled artisans to employ such variations as appropriate, and the inventors intend for the disclosed subject matter to be practiced otherwise than specifically described herein. Accordingly, the disclosed subject matter includes all modifications and equivalents of the subject matter recited in the claims appended hereto as permitted by applicable law. Moreover, any combination of the above-described elements in all possible variations thereof is encompassed by the disclosed subject matter unless otherwise indicated herein or otherwise clearly contradicted by context.

The subject matter described above is provided by way of illustration only and should not be construed as limiting. Various modifications and changes may be made to the subject matter described herein without following the example embodiments and applications illustrated and described, and without departing from the true spirit and scope of the present disclosure, which is set forth in the following claims.

All publications, patents and patent applications cited in this specification are incorporated herein by reference in their entireties as if each individual publication, patent or patent application were specifically and individually indicated to be incorporated by reference. While the foregoing has been described in terms of various embodiments, the skilled artisan will appreciate that various modifications, substitutions, omissions, and changes may be made without departing from the spirit thereof.

1. A method of recovering sulfopolyester from a composite material, wherein the method comprises:
a. washing the composite material with a solvent composition to remove a portion of surface impurities and to form a washed composite material; wherein the washing is conducted at a temperature where less than 2% of the water-dispersible sulfopolyester is removed from the composite material; and wherein the composite material comprises a water-dispersible sulfopolyester and one or more water non-dispersible polymers;
b. opening the washed composite material with water at a temperature of greater than 60° C. to produce an aqueous dispersion and water non-dispersible polymers; wherein said aqueous dispersion comprises sulfopolyester; and
c. recovering sulfopolyester from the aqueous dispersion.

2. The method of claim 1, wherein the solvent composition consists essentially of water.

3. The method of claim 1, wherein the solvent composition comprises water and less than 5% of at least one surfactant.

4. The method of claim 3, wherein the one or more surfactants comprise anionic surfactants and/or non-ionic surfactants.

5. The method of claim 1, wherein the solvent composition comprises less than 10% of at least one organic solvent.

6. The method of claim 5, wherein the one or more organic solvents comprise alcohol, ketone, ether, and/or ester.

7. The method of claim 1, wherein washing is performed with the water at a temperature between 20° C. and 60° C.

8. The method of claim 1, wherein washing the composite material comprises contacting the composite material with shear force to remove at least a portion of the surface impurities.

9. The method of claim 1, wherein the washing is performed between 15 seconds to 15 minutes.

10. The method of any onc of claim 1, wherein the method further comprises mixing the washed composite material with treated water prior to opening the washed composite material, wherein the water has been treated to remove multivalent metal cations.

11. The method of claim 10, wherein concentration of multivalent metal cations in the treated water comprises less than 60 ppm by weight.

12. The method of claim 11, wherein concentration of the multivalent metal cations is less than 50 ppm by weight.

13. The method of claim 10, wherein temperature of treated water ranges from 10° C. to 40° C.

14. The method of claim 10, wherein opening and mixing the washed composite material with treated water are performed in one step.

15. The method of claim 1, wherein opening is performed with water at a temperature ranging from 61° C. to 140° C.

16. The method of claim 1, wherein opening is performed with shear force for a period of time from 10 secs to 10 minutes to remove at least a portion of surface impurities.

17. The method of claim 1, wherein the water-dispersible sulfopolyester comprises a salt of a sulfoisophthalate moiety.

18. The method of claim 1, wherein recovering sulfopolyester comprises removing water from the aqueous dispersion.

19. The method of claim 18, wherein water is removed by evaporation, by precipitation, or by using one or more membrane filtration systems.

20. The method of claim 19, wherein the one or more membrane filtration systems comprises one or more of an ultrafiltration system, a microfiltration system, or nanofiltration system.

21-70. (canceled)
